(19) United States
(12) Patent Application Publication
(10) Pub. No.: US 2016/0263477 A1
(43) Pub. Date: Sep. 15, 2016

(54) SYSTEMS AND METHODS FOR INTERACTIVE GAMING WITH NON-PLAYER ENGAGEMENT

(71) Applicant: LyteShot Inc., Chicago, IL (US)

(72) Inventors: Mark J. Ladd, Chicago, IL (US); Tuomas Ketola, Chicago, IL (US)

(21) Appl. No.: 15/067,071

(22) Filed: Mar. 10, 2016

Related U.S. Application Data
(60) Provisional application No. 62/131,121, filed on Mar. 10, 2015.

(51) Int. Cl. A63F 13/26; A63F 13/65; A63F 13/212

(52) U.S. Cl. CPC A63F 13/26; A63F 13/212; A63F 13/65

(57) ABSTRACT

The methods, systems, and non-transitory computer-readable media described herein allow non-players to view and/or participate in augmented reality electronic games without actively engaging in the primary gameplay of those electronic games. As described herein, an augmented field of view based on virtual objects, virtual items, and/or other items may be provided to non-players over a computer network, such as a 802-compliant wireless network or a cellular network coupled to player communications devices. Non-players may provide non-player interactions with aspects of the augmented reality electronic game, including but not limited to: introduction of gameplay elements, modifications of virtual objects, instructions to assist or impede players in gameplay, instructions to control sensors near a player, and/or transactions (purchases, etc.) in-game economies supported by the augmented reality electronic game.

### CLAIM OF PRIORITY

The present application claims priority under 35 U.S.C. §119(e) to provisional U.S. Pat. App. Ser. No. 62/131,121, filed Mar. 10, 2015, and entitled, “Interactive Gaming for Non-Player Viewing and Participation,” the contents of which are hereby incorporated by reference herein. The present application further incorporates by reference: provisional U.S. Pat. App. Ser. No. 62/073,652, filed Oct. 31, 2014, and entitled “Utilizing a Heads Up Display (HUD)/Head Mounted Display (HMD) with a Sensor-Based Mobile Gaming Platform;” U.S. patent application Ser. No. 14/247,199, filed Apr. 7, 2014, and entitled “Systems and Methods for Sensor-Based Mobile Gaming;” and U.S. patent application Ser. No. 14/930,613, filed Nov. 2, 2015, and entitled, “Interactive Gaming Using Wearable Optical Devices.”

### TECHNICAL FIELD

The technical field relates to systems and methods for interactive gaming on digital devices. More particularly, the technical field relates to systems and methods for facilitating non-player engagement with players of a sensor-based interactive games.

### BACKGROUND

Electronic games have long entertained many people. Many electronic games are hosted on personal computers or dedicated game consoles that have a processing or control unit, a display device, and a joystick, a keyboard, a mouse, trackpad, or other input device. The electronic games themselves typically relate to one or more genres, such as adventure genres, first-person shooting genres, automotive or aviation genres, role-playing or fantasy genres, sports genres, and collaborative social genres. The electronic games typically utilize gameplay, in-game objectives and virtual in-game objects (such as virtual characters, virtual items, virtual points, and video game levels) to facilitate competition or collaboration between one or more game players and a computer, and/or between two or more game players.

Though potentially informative and entertaining, conventional electronic games often do not effectively interface with the physical world. Systems and methods that allow game players to play electronic games while interfacing with the physical world would be desirable. Systems and methods that allow non-players who are not actively playing an electronic game to be engaged with an electronic game would also be desirable.

### SUMMARY

Most electronic games do not effectively interface with the physical world. People may receive greater enjoyment from electronic games that allow them to interact with the physical world, particularly electronic games that augment the physical world with virtual elements. The systems, methods, and non-transitory computer-readable media described herein allow people to play electronic games that augment reality (“augmented reality electronic games”) using sensor-based gaming hardware, wireless computing devices, and/or wearable optical devices. Locations of game players may be determined using the sensor-based gaming hardware, the wireless computing devices, the wearable optical devices, or some combination thereof. Depending on game players' locations, state(s) of the electronic game, and/or other factors, interactive virtual objects may be selected to augment game players' fields of vision. The game players may further interact with these virtual objects using the sensor-based gaming hardware, the wireless computing devices, the wearable optical devices, or some combination thereof. In various implementations, these interactive inputs may be used to change the state(s) of the electronic game, state(s) of the virtual objects, etc.

Additionally, the systems, methods, and non-transitory computer-readable media described herein allow non-players to view and/or participate in augmented reality electronic games without actively engaging in the primary gameplay of those electronic games. As described herein, an augmented field of view based on virtual objects, virtual items, and/or other items may be provided to non-players over a computer network, such as a 802-compliant wireless network or a cellular network coupled to player communications devices. Non-players may provide non-player interactions with aspects of the augmented reality electronic game, including but not limited to: introduction of gameplay elements, modifications of virtual objects, instructions to assist or impede players in gameplay, instructions to control sensors near a player, and/or transactions (purchases, etc.) in-game economies supported by the augmented reality electronic game. The systems, methods, and non-transitory computer-readable media described herein may support electronic sports markets and/or fantasy sports leagues related to augmented reality electronic gaming.

A computer-implemented method may include receiving first information of a physical player environment associated with gameplay, the first information comprising first video captured by a camera coupled to one or more first user devices of a player in the physical environment, and the first information further comprising physical attributes of the physical environment sensed by a first sensor in the physical environment. A gameplay action by the player may be identified, where the gameplay action has been taken by the player in relation to a second sensor in the physical environment. One or more virtual objects may be associated with the gameplay action based on one or more rules of the gameplay. An augmented field of view of the physical environment for the player may be created based on the virtual objects and the first information of the physical environment. The augmented field of view may be provided to one or more second user devices associated with a non-player, the non-player being remote from the physical environment. A non-player interaction with the virtual object may be received from the one or more second user devices, the non-player interaction being from the non-player. A gameplay state of the gameplay may be modified based on the non-player interaction.

In some embodiments, the non-player interaction comprises an introduction of a gameplay element into the gameplay. The non-player interaction may comprise a modification of the virtual object. The non-player interaction may comprise an instruction to assist the player in a game supported by the gameplay, or an instruction to impede the player in the game.

In various embodiments, the non-player interaction comprises an instruction to control the second sensor in the physical environment. The non-player interaction may comprise an instruction to control a third sensor in the physical environment. The non-player interaction may comprise a transaction in an in-game economy of a game supported by the gameplay. The transaction may comprise a purchase in the in-game economy.

The non-player interaction may be based on a virtual currency in an in-game economy of a game supported by the gameplay. The virtual currency may be based on a digital currency having a value outside the in-game economy. The augmented field of view may comprise a virtual map of a game supported by the gameplay.

In some embodiments, the first sensor comprises a depth sensor coupled to the camera, and the physical attributes of the physical environment comprise a mesh of the physical environment. The first sensor may comprise a positional tracking sensor coupled to the one or more first user devices, and the physical attributes of the physical environment comprise positional information of physical objects in the physical environment, the positional information captured by the positional tracking sensor. The positional tracking sensor may comprise one or more of a Global Positioning System (GPS) sensor, a Simultaneous Localization and Mapping (SLAM) sensor, and a Bluetooth Low Energy (BLE) sensor. The positional information may comprise one or more positional markers gathered by the positional tracking sensor.

In various embodiments, creating the augmented field of view of the physical environment comprises combining the virtual objects and the first information of the physical environment at a server remote from the one or more first user devices and the one or more second user devices. Further, creating the augmented field of view of the physical environment may comprise combining the virtual objects and the first information of the physical environment at the one or more second user devices.

In some embodiments, providing the augmented field of view comprises sending a streaming video of the augmented field of view to the one or more second user devices. Further in some embodiments, the augmented field of view may be sent to the one or more first user devices. The one or more first user devices may comprise at least one of: a heads-up-display (HUD), a mobile phone, and a tablet computing device.

In various embodiments, the camera comprises one or more of a mobile phone camera, a heads-up-display (HUD), and an action camera. The first video may be relayed to the one or more first user devices by the camera after the camera has captured the first video.

A system may comprise: a player device interface module configured to receive first information of a physical player environment associated with gameplay, the first information comprising first video captured by a camera coupled to one or more first user devices of a player in the physical environment, and the first information further comprising physical attributes of the physical environment sensed by a first sensor in the physical environment; a gameplay management module configured to identify a gameplay action by the player, the gameplay action being taken by the player in relation to a second sensor in the physical environment, to associate one or more virtual objects with the gameplay action based on one or more rules of the gameplay, and to create an augmented field of view of the physical environment for the player based on the virtual objects and the first information of the physical environment; a non-player device module configured to provide the augmented field of view to one or more second user devices associated with a non-player, the non-player being remote from the physical environment; a non-player interaction management module configured to process a non-player interaction with the virtual object, the non-player interaction being from the one or more second user devices associated with the non-player; and a non-player instruction processing module configured to instruct the gameplay management module to modify a gameplay state of the gameplay based on the non-player interaction, the game.

A non-transitory computer-readable medium comprising one or more processors and memory coupled to the one or more processors, the memory comprising computer-program instructions configured to instruct the one or more processors to perform a computer-implemented method, the computer-implemented method comprising: receiving first information of a physical player environment associated with gameplay, the first information comprising first video captured by a camera coupled to one or more first user devices of a player in the physical environment, and the first information further comprising physical attributes of the physical environment sensed by a first sensor in the physical environment; identifying a gameplay action by the player, the gameplay action being taken by the player in relation to a second sensor in the physical environment; associating one or more virtual objects with the gameplay action based on one or more rules of the gameplay; creating an augmented field of view of the physical environment for the player based on the virtual objects and the first information of the physical environment; providing the augmented field of view to one or more second user devices associated with a non-player, the non-player being remote from the physical environment; receiving from the one or more second user devices a non-player interaction with the virtual object, the non-player interaction being from the non-player; modifying a gameplay state of the gameplay based on the non-player interaction.

Other features and embodiments are apparent from the accompanying drawings and from the following detailed description.

### BRIEF DESCRIPTION OF THE DRAWINGS

FIG. 1A depicts an example of an augmented reality gaming environment, according to some embodiments.

FIG. 1B depicts an example of an augmented reality gaming environment, according to some embodiments.

FIG. 1C depicts an example of an augmented reality gaming environment, according to some embodiments.

FIG. 1D depicts an example of an interior view of a wearable optical device, according to some embodiments.

FIG. 1E depicts an example of an interior view of a wearable optical device, according to some embodiments.

FIG. 1F depicts an example of an interior view of a wearable optical device, according to some embodiments.

FIG. 2 depicts an example of a emitter, according to some embodiments.

FIG. 3 depicts an example of a receiver, according to some embodiments.

FIG. 4 depicts an example of a communications device, according to some embodiments.

FIG. 5 depicts an example of a wearable optical device, according to some embodiments.

FIG. 6 depicts an example of a gameplay system, according to some embodiments.

FIG. 7 depicts an example of a gameplay management module, according to some embodiments.

FIG. 8 depicts an example of a non-player engagement management system, according to some embodiments.

FIG. 9 depicts a flowchart of an example of a method for facilitating an augmented reality electronic game having one or more virtual objects, according to some embodiments.

FIG. 10 depicts a flowchart of an example of a method for rendering a virtual object in an augmented reality electronic game, according to some embodiments.

FIG. 11 depicts a flowchart of an example of a method for modifying a state of a virtual object in an augmented reality electronic game, according to some embodiments.

FIG. 12 depicts a flowchart of an example of a method for facilitating an augmented reality electronic game having one or more virtual objects, according to some embodiments.

FIG. 13 depicts a flowchart of an example of a method for facilitating non-player engagement with an augmented reality gaming system, according to some embodiments.

FIG. 14 depicts an example of a digital device, according to some embodiments.

FIG. 15A depicts an example of an augmented reality gaming system, according to some embodiments.

FIG. 15B depicts an example of an augmented reality gaming system, according to some embodiments.

FIG. 16 depicts a flowchart of an example of a method for facilitating non-player engagement with an augmented reality gaming system, according to some embodiments.

FIG. 17 depicts an example of a facility used to facilitate non-player engagement with an augmented reality gaming system, according to some embodiments.

FIG. 18 depicts an example screen of a non-player communications device used to facilitate non-player engagement with an augmented reality gaming system, according to some embodiments.

### DETAILED DESCRIPTION

### Example Augmented Reality Gaming Systems

### Example System Architecture

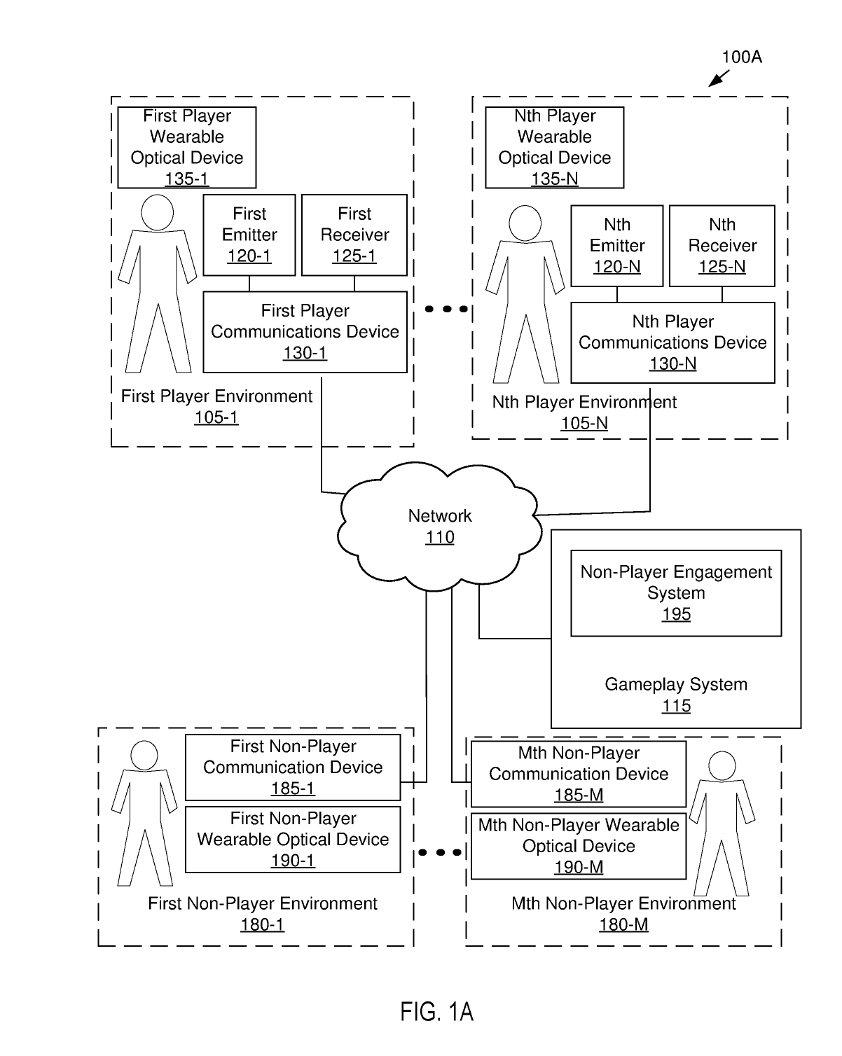

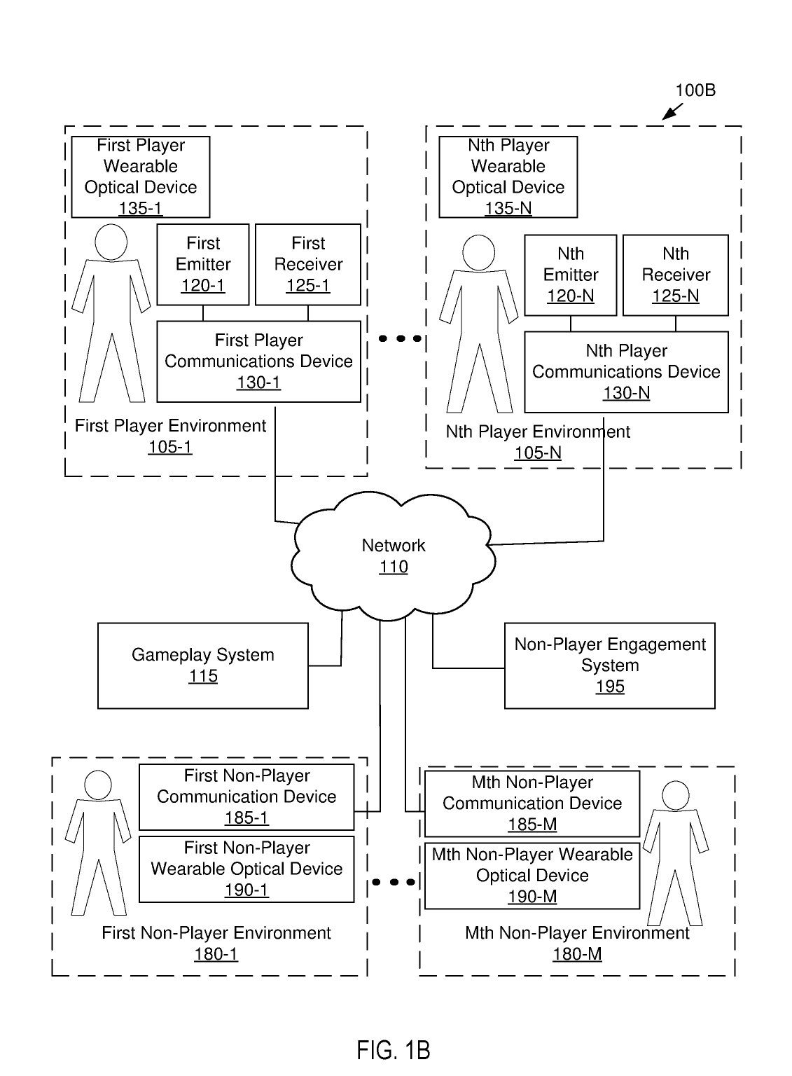

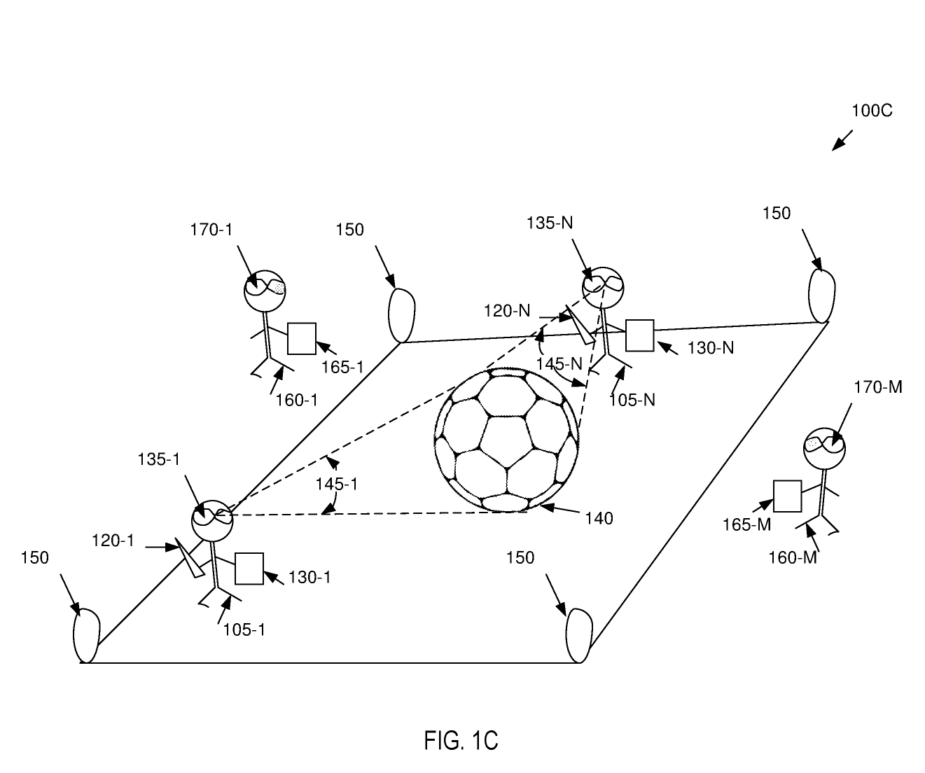

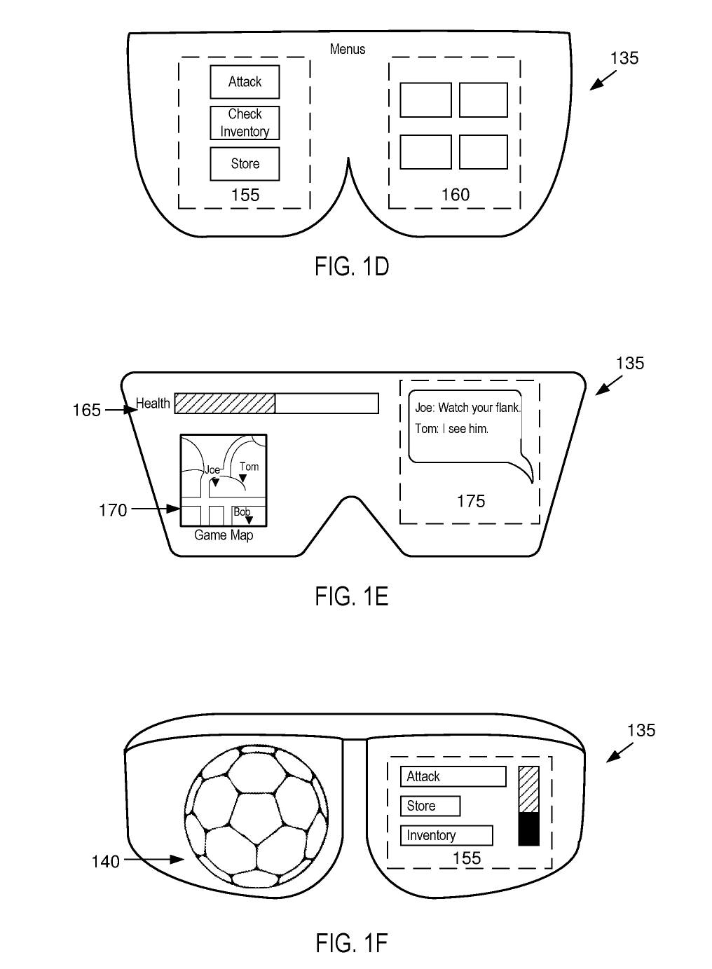

FIG. 1A depicts an example of an augmented reality gaming environment 100A, according to some embodiments. The augmented reality gaming environment 100A includes a plurality of player environments 105 (illustrated in FIG. 1A as a first player environment 105-1 through an Nth player environment 105-N (where N is an arbitrary positive integer)), a network 110, a gameplay system 115, a non-player engagement system 195, and a plurality of non-player environments 180 (illustrated in FIG. 1A as a first non-player environment 180-1 through an Mth non-player environment 180-M (where M is a positive integer, and the integer M may or may not be the same as the integer N).

The first player environment 105-1 may comprise one or more devices associated with a first player or set of players. A “player,” as used herein, may refer to any person or group of persons who engage in the primary gameplay of an electronic game. The first player environment 105-1 may include a first emitter 120-1, a first receiver 125-1, a first player communications device 130-1, and a first player wearable optical device 135-1. The first emitter 120-1, the first receiver 125-1, and/or the first player wearable optical device 135-1 may be coupled to the first player communications device 130-1. The coupling may use any known or convenient format (a Bluetooth® connection (e.g., a Bluetooth Low Energy® connection), a 802.11 connection, a cellular connection, a bus, wire, or wires, etc.). As discussed further herein, the first emitter 120-1, the first receiver 125-1, and the first player communications device 130-1 may be used by a first player to engage in augmented reality electronic gameplay and/or augmented reality electronic gameplay.

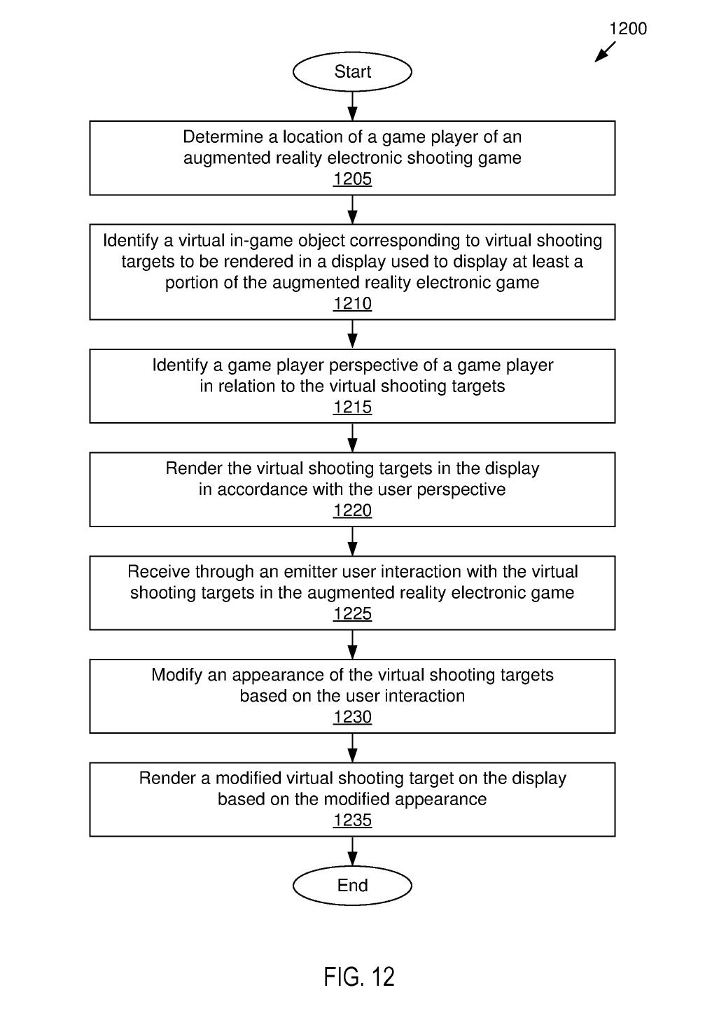

The first emitter 120-1 may comprise a digital device having a transmitter that emits an emitter signal to a receiver. A digital device, as used herein, may comprise any device having a processor and a memory. A digital device may comprise some or all of the components of the digital device 1200, shown in FIG. 12. The emitter signal may comprise one or more of a variety of electromagnetic signals. In various embodiments, the emitter signal may include an infrared signal, a Near Field Communications (NFC) signal, etc. The emitter signal may comprise a beam that is directed at the receiver. The beam may be encoded with a unique identifier corresponding to the first emitter 120-1. The first emitter 120-1 may provide information related to the emitter signal to the first player communications device 130-1. The first emitter 120-1 may be controlled by the first player communications device 130-1. The first emitter 120-1 may be incorporated into a modular peripheral device, that is, a device that is provided using a hardware development kit. An example of a hardware development kit includes a set of plans that players can print on a three-dimensional (3D) printer using a template in the kit.

In some embodiments, the first emitter 120-1 may take the form of a weapon used in augmented reality electronic gameplay. For example, the first emitter 120-1 may be a gun, a bow, a sword, a wand, a grenade, or other weapon. The first emitter 120-1 may have an interaction recognition mechanism that recognizes interactions with the first emitter 120-1 and/or instructs the transmitter of the first emitter 120-1 to emit the emitter signal. The interaction recognition mechanism may have a variety of forms.

As various examples, the interaction recognition mechanism may comprise: a shoot mechanism corresponding to a trigger on a gun, a motion recognition mechanism that recognizes body movements that correspond to motions taken by a user of a bow, a sword, a wand, grenade, etc. As additional examples, in embodiments where the first emitter 120-1 comprises a gun, the interaction recognition mechanism may appear as a finger-based trigger. When the finger-based trigger is activated, the first emitter 120-1 may emit the emitter signal. As another example, in embodiments where the first emitter 120-1 comprises a grenade, the interaction recognition mechanism may appear as a grenade clip that instructs emission of the emitter signal after expiration of a specified time. It is noted the first emitter 120-1 need not have an interaction recognition mechanism, and may emit the emitter signal upon occurrence of any number of specified events. It is further noted, in various embodiments, the first emitter 120-1 need not take the form of a weapon, and may instead take some other form. For instance, in some embodiments, the first emitter 120-1 may take the form of a search device used in scavenger-hunting gameplay. In various embodiments, the first emitter 120-1 may be wearable. For example, the first emitter 120-1 may be integrated into a piece of clothing to be worn on a player.

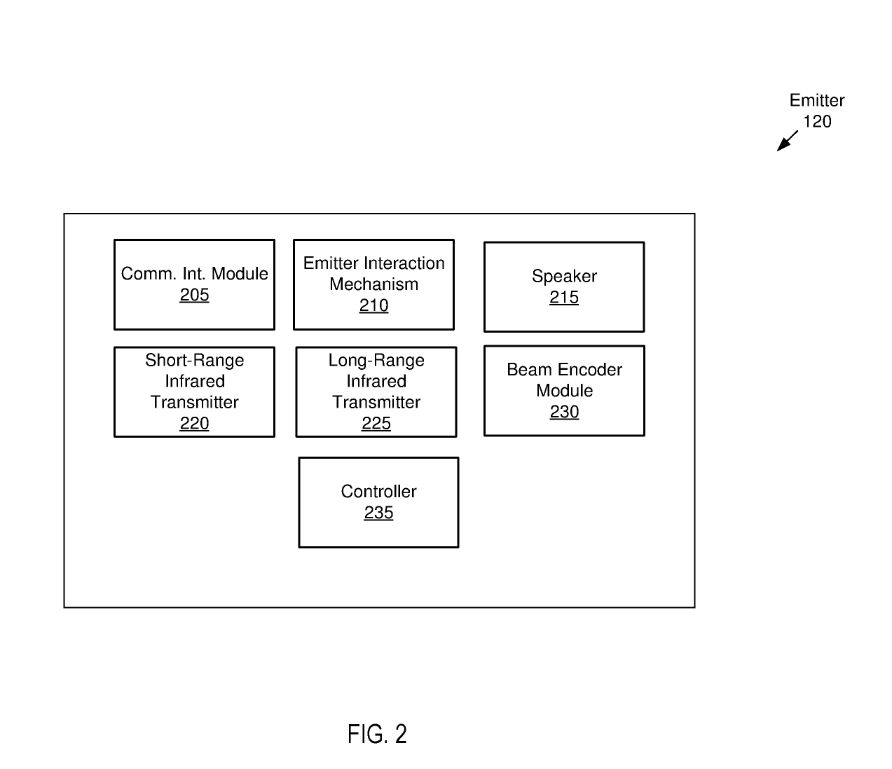

Further, in some embodiments, the first emitter 120-1 may include hardware, software, and/or firmware to trigger data export to the first player communications device 130-1 at various times, including: when the first emitter 120-1 is initially coupled to the first player communications device 130-1, when a player has taken an action on the first emitter 120-1, and when the first emitter 120-1 is decoupled from the first player communications device 130-1. In various embodiments, the first emitter 120-1 may have some or all of the components of the emitter 120, shown in FIG. 2.

The first receiver 125-1 may comprise a digital device configured to receive an emitter signal. The first receiver 125-1 may receive the emitter signal from an emitter associated with another player (e.g., the Nth emitter 120-N). If the emitter signal is encoded with the identity of an emitter, the first receiver 125-1 may decode the emitter signal. The first receiver 125-1 may provide to the first player communications device 130-1 a receiver signal corresponding to the received emitter signal. The first receiver 125-1 may be controlled by the first player communications device 130-1. The first receiver 125-1 may be incorporated into a modular peripheral device.

In particular embodiments, the first receiver 125-1 may have a form compatible with augmented reality electronic gameplay. More specifically, the first receiver 125-1 may be configured to register in-game actions, such as shots, hits, outcomes of spells, etc. In gameplay where the first emitter 120-1 is configured as a gun, for instance, the first receiver 125-1 may be configured to receive a beam from the emitter 120-1. In gameplay where the first emitter 120-1 is configured as a sword, the first receiver 125-1 may be configured as a tunic or other wearable item configured to receive a touch by the first emitter 120-1, in one example. In gameplay where the first emitter 120-1 is configured as a grenade, the first receiver 125-1 may be configured to receive emitter signals from an approximate point source corresponding to the location of the first emitter 120-1. In gameplay where the first emitter 120-1 is configured for scavenger hunt games, the first receiver 125-1 may include an identifier, such as a Quick Response (QR) Code that facilitates access to items in gameplay. In combat-based gameplay embodiments, the first receiver 125-1 may provide such an identifier. In gameplay defined by a geographical region (e.g., gameplay having geo-fenced boundaries), the first receiver 125-1 may comprise a disk, puck, biscuit, etc. that is placed within the geographical region and receives information related position from the first emitter 120-1. As examples, the first receiver 125-1 may include BLE or Wi-Fi hardware that allows distance to the first emitter 120-1 to be determined with a specified degree of accuracy.

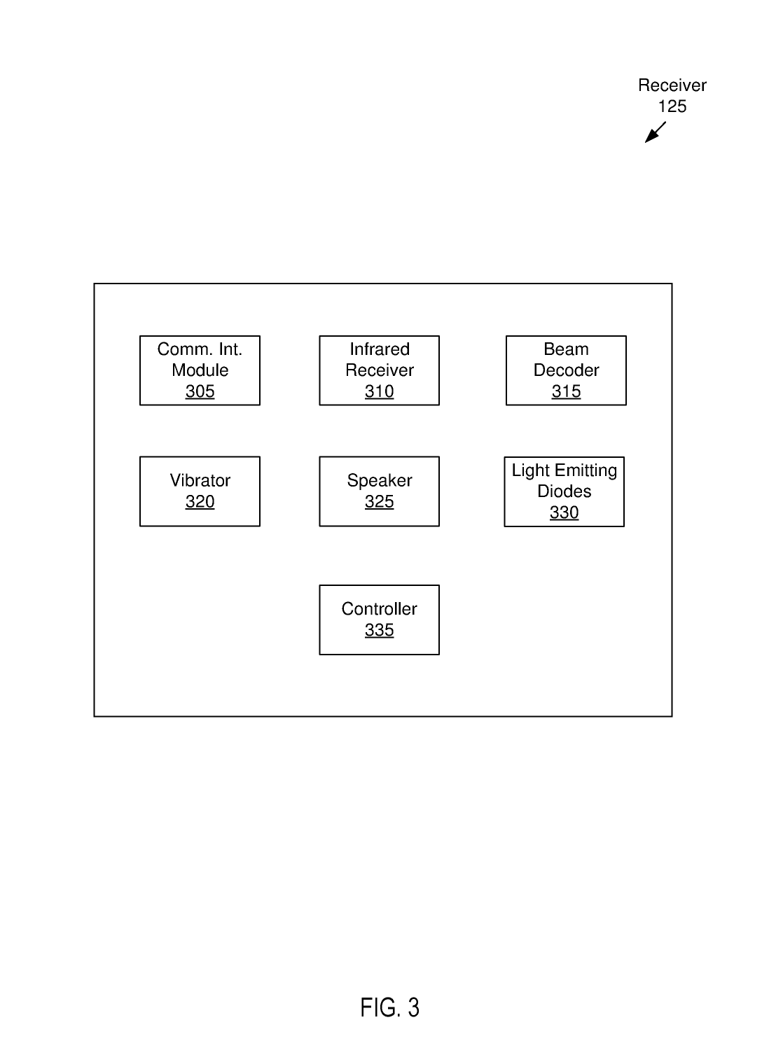

In various embodiments, the first receiver 125-1 may trigger data export to the first player communications device 130-1 at various times, including: when the first receiver 125-1 is initially coupled to the first player communications device 130-1, when the first receiver 125-1 has indicated some action (e.g., a valid hit) has been taken on the first receiver 125-, and when the first receiver 125-1 is decoupled from the first player communications device 130-1. In various embodiments, the first receiver 125-1 may have some or all of the components of the receiver 125, shown in FIG. 3.

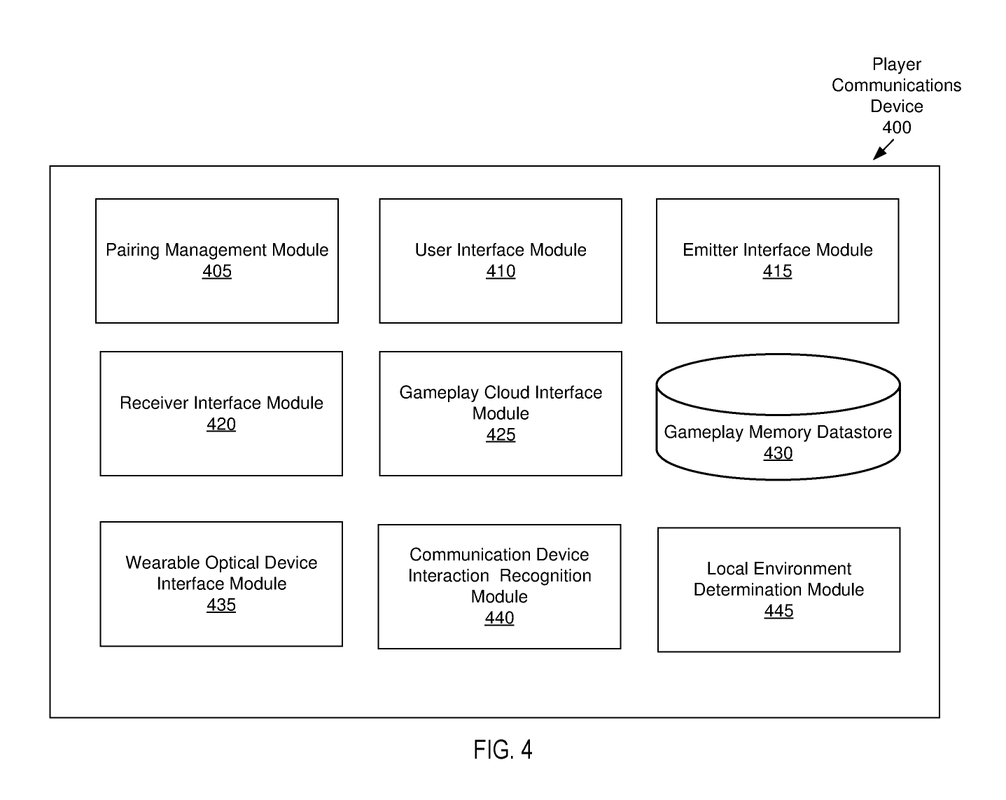

The first player communications device 130-1 may comprise a digital device configured to control the first emitter 120-1, the first receiver 125-1, and/or the first player wearable optical device 135-1. In various embodiments, the first player communications device 130-1 may be one or more of: a mobile phone, a tablet computing device, a desktop computer, a laptop computer, or other digital device. The first player communications device 130-1 may have some or all of the components of the communications device 400, shown in FIG. 4.

In some embodiments, the first player communications device 130-1 supports augmented reality electronic gameplay using the first emitter 120-1, the first receiver 125-1, the gameplay system 115, and/or the first player wearable optical device 135-1. The first player communications device 130-1 may receive emitter signals from the first emitter 120-1. The first player communications device 130-1 may further receive the receiver signal from the first receiver 125-1. In various embodiments, the first player communications device 130-1 may provide the first player with an application that presents augmented reality electronic gameplay. The application may include data, services, and other information obtained from the gameplay system 115. The application may have been downloaded from an application store or installed using other methodologies. The application may support in-game purchases and/or in-game advertising. In various embodiments, through the use of geo-fencing, the application may give any venue (retail stores, restaurants, shopping or other malls, stadiums, movie theaters, etc.) the ability to run promotions, drive advertisement revenue, and encourage the social sharing of their brand to the player's game app on their phone.

Though FIG. 1A and FIG. 1B show the first player communications device 130-1 associated with a first player, it is noted, in various embodiments, the first player communications device 130-1 need not be associated with a human being. Rather, in various embodiments, the first player communications device 130-1 may be associated with and/or controlled by a digital device. The first player communications device 130-1 may be controlled by an inanimate entity that, in turn receives instructions from the gameplay system 115. In such embodiments, the first emitter 120-1 and/or the first receiver 125-1 may be associated with the inanimate entity. Taking the example of a scavenger hunt game, the first receiver 125-1 may correspond to an inanimate object that is to be discovered as an object of gameplay.

In some embodiments, the first player communications device 130-1 may not have access or may have only limited access to the network 110 while gameplay is underway. For example, the first player communications device 130-1 may not have access to a cellular or Wi-Fi network during augmented reality electronic gameplay. In these embodiments, the first player communications device 130-1 may cache or otherwise store data associated with the augmented reality electronic gameplay and provide the data to the gameplay system 115 when there is connectivity or sufficient connectivity to the network 110.

The first player wearable optical device 135-1 may comprise a digital device configured to display virtual objects to the first player. A “virtual object,” as used herein, may refer to any object that is displayed on a display of a digital device and that is not part of the physical world. Virtual objects may include portions of a graphical user interface (GUI), such as menus, radio buttons, text fields, visible web and/or application components, or the like. Virtual objects may, but need not, comprise virtual in-game objects, such as elements of an electronic game that change state in response to a user's inputs/interactions. Examples of virtual in-game objects further include virtual characters, virtual items, virtual points, game levels, or the like that are part of gameplay of an electronic game.

In some embodiments, the first player wearable optical device 135-1 renders virtual objects onto a display. The display may be transparent, translucent, opaque, etc. In implementations where the display is transparent or translucent, the first player wearable optical device 135-1 may superimpose virtual objects over a first perspective of the physical world. In implementations, the first player wearable optical device 135-1 may include or be coupled to external sensors and/or cameras (e.g., depth-sensing cameras) or other hardware configured to provide the first player with the first perspective. The first player wearable optical device 135-1 may include a positional tracking sensor that is coupled thereto. The positional tracking sensor may capture positional information of physical objects near the first player environment 105-1 and/or positional information of the first player. In various implementations, the positional tracking sensor comprises one or more of a Global Positioning System (GPS) sensor, a Simultaneous Localization and Mapping (SLAM) sensor, and/or a Bluetooth Low Energy (BLE) sensor. The positional information may comprise one or more positional markers gathered by the positional tracking sensor.

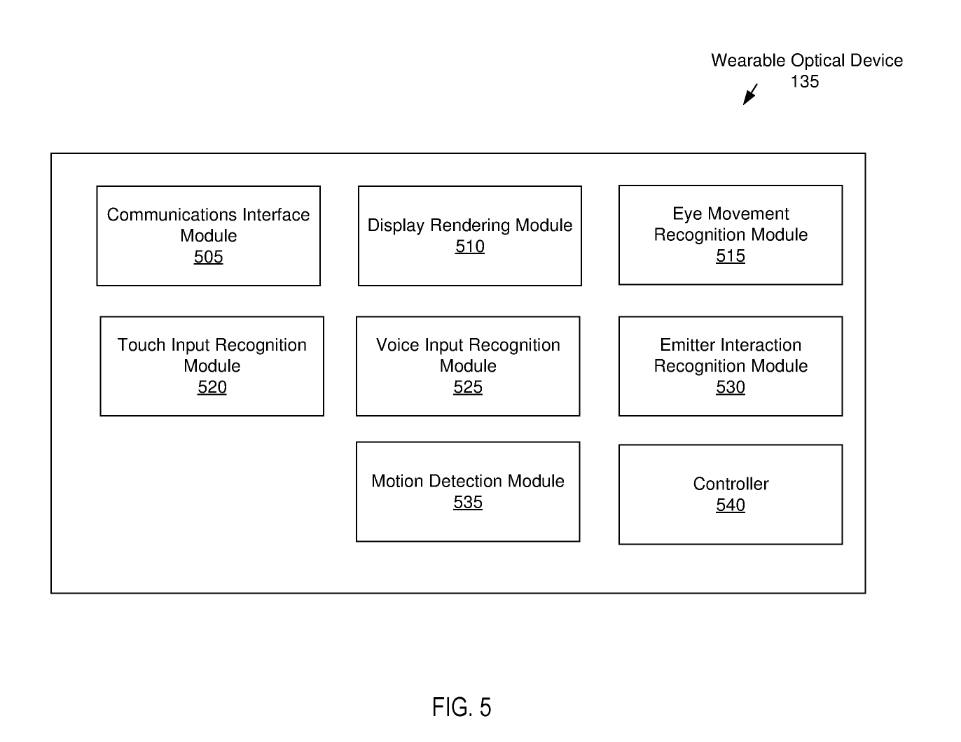

In various implementations, the first player wearable optical device 135-1 superimposes virtual objects over representations (images, video, streaming video, etc.) of the physical world. In various embodiments, the first player wearable optical device 135-1 provides one or more of augmented reality and virtual reality to the first player. Examples embodiments of the first player wearable optical device 135-1 include an Optical Head Mounted Display (e.g., a heads up display (HUD)), or an optical device mounted (mobile phone, action camera (e.g., a GoPro® camera), etc.) on or coupled to some portion of the first player's body or clothing. In various embodiments, the first player wearable optical device 135-1 has some or all of the components of the wearable optical device 500, shown in FIG. 5.

Though FIGS. 1A and 1B and portions of the description herein may describe the first player wearable optical device 135-1 as separate from the first emitter 120-1, the first receiver 125-1, and the first player communications device 130-1, it is noted that in various implementations, the first player wearable optical device 135-1 may be part of or connected to the first emitter 120-1, the first receiver 125-1, or the first player communications device 130-1. For example, in some embodiments, the first player wearable optical device 135-1 may include at least a portion of the display of the first player communications device 130-1. As another example, in various embodiments, the functionalities of the first player communications device 130-1 may be incorporated into (e.g., embedded in circuitry within) the first player wearable optical device 135-1. It is noted that in various embodiments, the first player wearable optical device 135-1 may also reside within one or more of the first emitter 120-1 and the first receiver 125-1.

The Nth player environment 105-N represents a set of devices associated with an Nth player or set of players. The Nth player environment 105-N comprises an Nth emitter 120-N, an Nth receiver 125-N, an Nth player communications device 130-N, and an Nth player wearable optical device 135-N. In various embodiments, the Nth emitter 120-N may be similar to the first emitter 120-1, discussed herein. The Nth receiver 125-N may be similar to the first receiver 125-1, discussed herein. The Nth player communications device 130-N may be similar to the first player communications device 130-1. The Nth player wearable optical device 135-N may be similar to the first player wearable optical device 135-1, discussed herein. In some embodiments, the devices in the Nth player environment 105-N engage in augmented reality electronic gameplay with the devices in the first player environment 105-1.

The network 110 may comprise a computer network. The network 110 may include technologies such as Ethernet, 802.11x, worldwide interoperability for microwave access WiMAX, 2G, 3G, 4G, CDMA, GSM, LTE, digital subscriber line (DSL), and/or the like. The network 110 may further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and/or the like. The data exchanged over the network 110 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec). The network 110 may be coupled to the first player communications device 130-1, to the Nth player communications device 130-N, and to the gameplay system 115. In various embodiments, though not shown in FIG. 1, the network 110 may be coupled to one or more of the first emitter 120-1, the first receiver 125-1, the Nth emitter 120-N, and the Nth receiver 125-N.

The first non-player environment 180-1 may comprise one or more devices associated with a first non-player or set of non-players. A “non-player,” as used herein, may refer to any person or group of people who do not engage in the primary gameplay of an electronic game. Non-players may include passive non-players who do not participate in the electronic game but view portions of the electronic game (e.g., view progress of players and/or the electronic game, view electronic maps associated with electronic game, view transactions in the electronic game). Non-players may also include active non-players who participate in (but do not engage in the primary gameplay of) the electronic game by assisting and/or hindering the progress of players, affecting outcomes, entering into transactions in the electronic game, or the like. A non-player may, at some times, be a passive non-player, and, at other times, be an active non-player.

The first non-player environment 180-1 may include a first non-player communications device 185-1 and a first non-player wearable optical device 190-1. As discussed further herein, the first non-player communications device 185-1 and the first non-player wearable optical device 190-1 may be used by a first non-player to participate in augmented reality electronic games without engaging in the primary gameplay of the augmented reality electronic games.

The first non-player communications device 185-1 may comprise a digital device coupled to the network 110. In various embodiments, the first non-player communications device 185-1 may be one or more of: a mobile phone, a tablet computing device, a desktop computer, a laptop computer, or other digital device. The first non-player communications device 185-1 may have some or all of the components of the communications device 400, shown in FIG. 4.

In various embodiments, the first non-player communications device 185-1 allows non-players to participate in augmented reality electronic games without engaging in the primary gameplay of these electronic games. As discussed further herein, the first non-player communications device 185-1 may control one or more aspects of electronic games maintained by the gameplay system 115. In some embodiments, the first non-player communications device 185-1 may control one or more devices in the player environments 105 without requiring the non-players to engage in the primary gameplay maintained by an augmented reality electronic game.

The first non-player wearable optical device 190-1 may comprise a digital device configured to display virtual objects to the first non-player. In some embodiments, the first non-player wearable optical device 190-1 renders virtual objects onto a display. The display may be transparent, translucent, opaque, etc. In implementations where the display is transparent or translucent, the first non-player wearable optical device 190-1 may superimpose virtual objects over a first perspective of the physical world. In implementations where the display is opaque, the first non-player wearable optical device 190-1 may include or be coupled to external cameras (e.g., depth-sensing cameras) or other hardware configured to provide the first user with the first perspective. In such implementations, the display may superimpose virtual objects over representations (images, video, streaming video, etc.) of the physical world. In various embodiments, the first non-player wearable optical device 190-1 provides one or more of augmented reality and virtual reality to the first user. Examples embodiments of the first non-player wearable optical device 190-1 include an Optical Head Mounted Display (e.g., a heads up display (HUD)), or an optical device (mobile phone, action camera (e.g., a GoPro® camera), etc.) mounted on or coupled to some portion of the first user's body or clothing. In various embodiments, the first non-player wearable optical device 190-1 has some or all of the components of the wearable optical device 500, shown in FIG. 5.

Though FIGS. 1A and 1B and portions of the description herein may describe the first non-player wearable optical device 190-1 as separate from the first non-player communications device 185-1, it is noted that in various implementations, the first non-player wearable optical device 190-1 may be part of or connected to first non-player communications device 185-1. For example, in some embodiments, the first non-player wearable optical device 190-1 may include at least a portion of the display of the first non-player communications device 185-1. As another example, in various embodiments, the functionalities of the first non-player communications device 185-1 may be incorporated into (e.g., embedded in circuitry within) the first non-player wearable optical device 190-1.

The Mth non-player environment 180-M represents a set of devices associated with an Mth player or set of players. The Mth non-player environment 180-M comprises an Mth non-player communications device 185-N, and an Mth non-player wearable optical device 190-M. The Mth non-player communications device 185-M may be similar to the first non-player communications device 185-1. The Mth non-player wearable optical device 190-M may be similar to the first non-player wearable optical device 190-1, discussed herein. In some embodiments, the devices in the Mth non-player environment 180-M allow non-players to participate in augmented reality electronic games without engaging in the primary gameplay of these electronic games.

The gameplay system 115 may comprise one or more digital devices configured to support processes, applications, etc. on the player communications devices 130. The gameplay system 115 may include dedicated, shared, or distributed servers. In some implementations, the gameplay system 115 supports augmented reality electronic gameplay by the player communications devices 130. In various embodiments, the gameplay system 115 may facilitate creation of new games, and/or may manage player accounts. The gameplay system 115 may also allow for the management of aspects of existing electronic games. For instance, in some embodiments, the gameplay system 115 may track successful or unsuccessful actions by emitters associated with players. The gameplay system 115 may provide to communications devices whether an action by a particular emitter successfully registered at a particular receiver. The gameplay system 115 may further provide instructions to the player wearable optical devices 135 to display virtual objects. In some embodiments, the gameplay system 115 may have some or all of the components of the gameplay system 115, shown in FIG. 5.

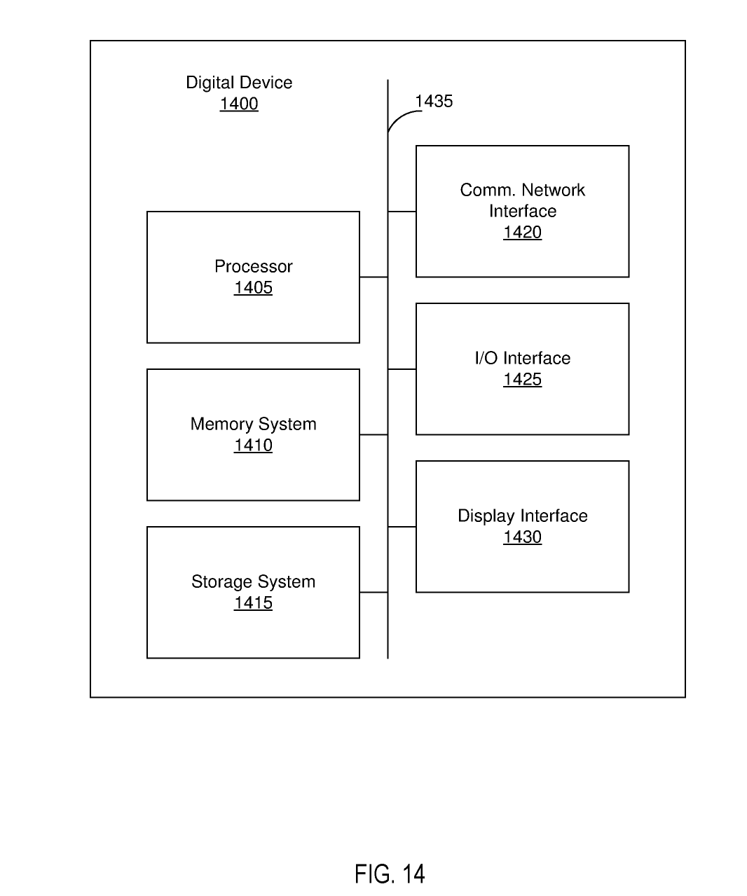

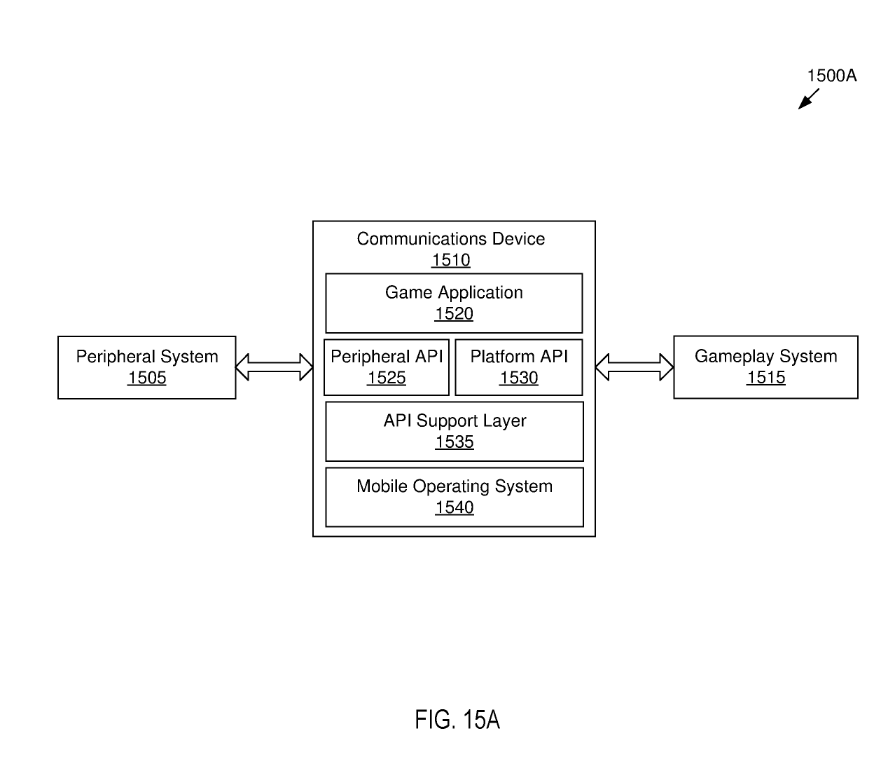

The gameplay system 115 may comprise a non-player engagement system 195. In the example of FIG. 1A, the non-player engagement system 195 is shown incorporated into the gameplay system 115. In some embodiments, however, the non-player engagement system 195 need not be incorporated into the gameplay system 115 and/or may be coupled to the gameplay system 115 through a network connection over the network 110 (see, e.g., FIG. 1B). As discussed further herein, the non-player engagement system 195 may allow the non-player communications devices 185 to provide non-player interactions, i.e., instructions by non-players to control or otherwise interact with gameplay maintained by the gameplay system 115. More specifically, in some embodiments, the non-player engagement system 195 allows non-players to enter into non-player transactions supported by an electronic game. Further, in various embodiments, the non-player engagement system 195 allows non-players to control one or more of the emitters 120, the receivers 125, the player communications devices 130, and the player wearable optical devices 135, either as part of or separate from, gameplay maintained by the gameplay system 115. In some embodiments, the non-player engagement system 195 has some or all of the components of the non-player engagement system 195, shown in FIG. 14.

FIG. 1A depicts a first emitter 120-1 through an Nth emitter 120-N, a first receiver 125-1 through an Nth receiver 125-N, a first player communications device 130-1 through an Nth player communications device 130-N, a first player wearable optical device 135-1 through an Nth player wearable optical device 135-N, a first non-player communications device 185-1 through a Mth non-player communications device 185-M, and a first non-player wearable optical device 190-1 through an Mth non-player wearable optical device 190-M in order to illustrate various implications of multiple players of sensor-based mobile gameplay. However, it is noted portions of the discussion herein refer to an “emitter 120” or “emitters 120,” a “receiver 125” or “receivers 125”, a “player communications device 130” or “player communications devices 130,” a “player wearable optical device 135” or “player wearable optical devices 135,” a “non-player communications device 185” or “non-player communications devices 185,” and a “non-player wearable optical device 190” or “non-player wearable optical devices 190” for simplicity.

FIG. 1B depicts an example of an augmented reality gaming environment 100B, according to some embodiments. The elements in FIG. 1B correspond to their counterparts in FIG. 1A. The implementation in FIG. 1B, however, shows the non-player engagement system 195 residing outside the gameplay system 115, and coupled to the gameplay system 115 over the network 110. In these embodiments, the non-player engagement system 195 comprises one or more digital devices configured to facilitate engagement between the non-player communications devices 185 and the gameplay system 115.

FIG. 1C depicts an example of an augmented reality gaming environment 100C, according to some embodiments. The augmented reality gaming environment 100C may include the first player environment 105-1 (having therein the first emitter 120-1, the first receiver 125-1, the first player communications device 130-1, and the first player wearable optical device 135-1); the Nth player environment 105-N (having therein the Nth emitter 120-N, the Nth receiver 125-N, the Nth player communications device 130-N, and the Nth player wearable optical device 135-N); the first non-player environment 180-1 (having therein the first non-player communications device 185-1 and the first non-player wearable optical device 190-1); and the Mth non-player environment 180-M (having therein the Mth non-player communications device 185-M and the Mth non-player wearable optical device 190-M).

The augmented reality gaming environment 100C may further include a virtual in-game object 140 that is displayed on the first player wearable optical device 135-1 and the Nth player wearable optical device 135-N but is not present in the physical world. The first player wearable optical device 135-1 may display the virtual in-game object 140 at a first perspective 145-1, and the Nth player wearable optical device 135-N may display the virtual in-game object 140 at an Nth perspective 145-N.

The first non-player wearable optical device 190-1 and/or the Mth non-player wearable optical device 190-M may display the virtual in-game object 140 at the first perspective 145-1 and/or the Nth perspective 145-N (that is, the non-player wearable optical device 190 may be configured to display the virtual in-game object according to a perspective of a player of the game). In some implementations, the non-player wearable optical device 190 may display other information about the augmented reality electronic game, such as a map of a virtual space associated with the game, points of players, health of players, etc.

The first non-player communications device 185-1 and/or the Mth non-player communications device 185-M may receive and process instructions to change a gameplay state of the augmented reality electronic game. In various embodiments, the first non-player communications device 185-1 and/or the Mth non-player communications device 185-M may receive and process instructions to control one or more of the emitters 120, one or more of the receivers 125, and/or the virtual in-game object 140.

The augmented reality gaming environment 100C may be defined by geo-fences 150. Each of the geo-fences 150 may limit the areas the augmented reality electronic game can be played. Although the virtual in-game object 140 is depicted as a ball, it will be appreciated that the virtual in-game object 140 may be any creature (e.g., alien, human, animal, dragon, or the like), animated object, or inanimate object. There may be any number of virtual in-game objects 140 in the augmented reality gaming environment 100C.

FIG. 1D depicts an example of an interior view of a player wearable optical device 135, according to some embodiments. The interior view in FIG. 1D includes a virtual inventory 155 of virtual items and a menu 160 for selecting actions. Each of the virtual inventory 155 and the menu 160 may be formed from virtual objects for an augmented reality electronic game.

FIG. 1E depicts an example of an interior view of a player wearable optical device 135, according to some embodiments. The interior view in FIG. 1E includes a virtual health monitor 165, a virtual map 170, and a notification object 175. The virtual health monitor 165 may depict the health of a game player in an augmented reality electronic game; the virtual map 170 may depict a map of a virtual world in the augmented reality electronic game; and the notification object 175 may provide notifications related to the an augmented reality electronic game. Each of the virtual health monitor 165, the virtual map 170, and the notification object 175 may be formed from virtual objects for an augmented reality electronic game.

FIG. 1F depicts an example of an interior view of a player wearable optical device 135, according to some embodiments. The interior view in FIG. 1F includes a representation of the virtual in-game object 140 and the virtual inventory 155. The representation of the virtual in-game object 140 and the virtual inventory 155 may be formed from virtual objects for an augmented reality electronic game.

Example Operation of Non-Player Engagement with Augmented Reality Gaming Systems

In various embodiments, the augmented reality gaming environment 100A allows one or more game players to play augmented reality electronic games that are supported by the data available over the network 110 (e.g., over the Internet). The augmented reality electronic games may comprise forms of alternate reality gaming in which aspects of the physical world are incorporated into mobile gameplay, and/or in which the physical world is augmented with virtual in-game objects 140 from the electronic game. The gaming experience provided by the augmented reality gaming environment 100A may provide new dimensions to outdoor games by leveraging smartphone technologies and the Internet, and bridging conventional gaming divides between the real world and digital worlds by combining physical participation, geo-locational data, social networking data, and elements of games (such as action and/or role-playing games). The gameplay system 115 may also provide messaging and/or social media capabilities for players to communicate with each other. The augmented reality electronic game may be developed using a Game Development Kit (GDK).

Augmented reality electronic games supported by the augmented reality gaming environment 100A and/or the augmented reality gaming environment 100C may include actions game players take against each other as well as actions game players take against virtual in-game objects 140 rendered in wearable optical device(s) 135. In some implementations, the augmented reality electronic games may allow game players can use emitter(s) 120 to register hits against receiver(s) 125 (e.g., combat or adventure genres that allow players to simulate battles with one another). In a combat game, for instance, players may use emitters to attempt in-game actions, and receivers to register successful in-game actions. In such a game, the first emitter 120-1 may emit an emitter signal toward the Nth receiver 125-N each time the first player attempts to attack the Nth player. The in-game actions may correspond to a gun being shot, a sword being swung, or a grenade being launched. Emitter signals from the first emitter 120-1 may be encoded with the identity of the first emitter 120-1. The first emitter 120-1 may provide the first player communications device 130-1 with information about in-game action attempts. By using emitters and receivers to register game actions, the augmented reality gaming environment 100A may allow players to verify the actions of other players. Players need not wonder whether, for instance, the first emitter 120-1 accurately took an action with respect to the Nth receiver 125-N. More specifically, the augmented reality gaming environment 100A may allow users to use technologies such as geo-locational technologies, infrared technologies, and data available over the network 110 to provide real-time feedback of gameplay between players.

In some implementations, the Nth receiver 125-N may register successful in-game actions each time the emitter signal successfully contacts the Nth receiver 125-N. For each successful in-game action, the Nth receiver 125-N may decode received emitter signals as needed. The Nth receiver 125-N may further provide information about successful in-game actions to the Nth player communications device 130-N, which in turn may provide this information to the gameplay system 115. In these embodiments, the gameplay system 115 may provide information about the in-game actions, whether successful or not, to the first player communications device 130-1 and the Nth player communications device 130-N. The first player communications device 130-1 and the Nth player communications device 130-N may update user interface elements thereon accordingly.

In some implementations, the augmented reality electronic games supported by the augmented reality gaming environment 100A and/or the augmented reality gaming environment 100C may render the virtual in-game objects 140 in game players' wearable optical device(s) 135 and may allow game players to take actions against the virtual in-game objects 140. More specifically, the gameplay system 115 may determine the location of a game player using one or more location determination techniques. One example of location determination techniques that may be employed includes obtaining the game player's location through Global Positioning System (GPS) coordinates on a player communications device 130. Another example of location determination techniques that may be employed includes placing physical sensors (e.g., SLAM sensors) in one or more of the receiver(s) 125, and identifying locations of emitter(s) 120 within a geo-fenced region around those physical sensors (e.g., the region within the geo-fences 150). In various embodiments, the physical sensors may determine attributes such as altitude, distance, angular orientation, etc. of the emitter(s) 120 within the geo-fenced region. Yet another example of location determination techniques includes placing beacons (e.g., BLE beacons) within a geo-fenced region and using proximity of emitter(s) 120 to beacons to determine locations of game players. It is noted that some combination of these techniques may be employed in various implementations.

Moreover, the gameplay system 115 may select virtual in-game objects 140 to render in wearable optical device(s) 135. The selection of virtual in-game objects 140 may depend on a variety of factors, such as a state of gameplay and the location of a game player in the physical world. As examples, the gameplay system 115 may select virtual in-game objects 140 based on a level a game player is encountering in an augmented reality electronic game, the status of a game player within the level, the health of the game player, the number of points or virtual items the game player has earned, the status, levels, etc. of another player in the augmented reality electronic game, etc. As yet another example, the gameplay system 115 may select virtual items such as graphical elements that represent a game player's health, points, and virtual goods if these virtual items are associated with a gameplay status of the game player at a given time and/or physical location. As another example, the gameplay system 115 may select a virtual in-game object 140 corresponding to a three-dimensional representation of a dragon if game players in an augmented reality electronic game are to fight a dragon as part of gameplay.

In some embodiments, the gameplay system 115 provides the wearable optical device(s) 135 with an augmented field of view. An “augmented field of view,” as used herein, may refer to a view of a physical environment with virtual objects superimposed thereon. As an example, the gameplay system 115 may identify specific virtual in-game objects to place on the wearable optical device(s) 135; a player may be able to see the virtual in-game objects over a relevant perspective of the physical world.

The gameplay system 115 may render the selected virtual in-game objects 140 in wearable optical device(s) 135. The rendering of virtual in-game objects 140 may depend on a variety of factors, such as a state of gameplay and a perspective of a game player viewing the virtual in-game object 140 through a wearable optical device associated with the game player. To continue the foregoing examples, the gameplay system 115 may render perspectives of virtual in-game objects 140 based on a level a game player is encountering in an augmented reality electronic game, the status of a game player within the level, the health of the game player, the number of points or virtual items the game player has earned, the status, levels, etc. of another player in the augmented reality electronic game, etc. Further, the gameplay system 115 may render portions of a three-dimensional representation of a dragon that game players are expected to see based on an estimated perspective(s) of the game players. In a multi-player game, as a result, the gameplay system 115 may render multiple perspectives of the dragon; each of the multiple perspectives may depend on angles, distances, etc. between game players and the coordinates of the dragon in augmented reality. In various implementations, the gameplay system 115 accesses Computer Aided Design (CAD) files (e.g., Unity® files) related to in-game objects for rendering into wearable optical device(s) 135.

The gameplay system 115 may allow game players to interact with the virtual in-game object 140 by taking one or more actions against the virtual object. More specifically, in some embodiments, the gameplay system 115 allows game players to take actions against virtual in-game objects 140 using the emitter interaction mechanism on the emitter 120. Examples of such actions may correspond to shooting of a gun, swinging of a sword, making a motion corresponding to casting a spell using a wand, throwing a grenade, and picking up an item during a scavenger hunt. In various embodiments, the gameplay system 115 allows game players to take actions against virtual in-game objects 140 using gestures or other user input on the player communications device 130. Examples of such actions include switching weapons or reloading a weapon using radio buttons on the graphical user interface of the player communications device 130. In some embodiments, the gameplay system 115 allows game players to take actions against virtual in-game objects 140 using the player wearable optical device 135. Examples of such actions include voice commands, touch gestures on hardware on the player wearable optical device 135, eye movements that are tracked by the player wearable optical device 135, and motions detected by the player wearable optical device 135 (pitch, roll, yaw, tilts, translations, any motion observed by an accelerometer or gyroscope, etc.).

The gameplay system 115 may register the game player's actions against the virtual in-game object 140 by recording the actions against the virtual object. The gameplay system 115 may further modify the state of the virtual in-game object 140 based on the actions against the virtual object. To continue the foregoing examples, in augmented reality electronic games involving virtual in-game objects 140 corresponding to representations of dragons, successful “hits” by the emitter 120 may be registered as injuries to the dragon. In response to such hits, the gameplay system 115 may render the dragon in a diminished capacity. As yet another example, if a game player could not defend against an attack by the dragon, the gameplay system 115 may reduce a virtual representation of the game player's in-game health. In various embodiments, the gameplay system 115 may base, at least in part, a gameplay state on non-player interactions from the non-player engagement system 195.

In various embodiments, the non-player engagement system 195 may configure the non-player wearable optical device(s) 190 to display the augmented field of view of one or more of the players (e.g., the augmented field of view displayed on the player wearable optical device(s) 135). As a result, non-players may view on the non-player wearable optical device(s) 190 virtual in-game objects superimposed over a player's view of the physical world. Further, in some embodiments, the non-player engagement system 195 may configure the non-player wearable optical device(s) 190 to display virtual in-game objects, virtual maps of electronic games, other virtual items, etc. These virtual items may, but need not, correspond to the augmented field of view of game players.

The non-player communications device(s) 185 may further operate to receive from the non-players communications device(s) 185 non-player interactions with augmented reality electronic games. The non-player interactions may comprise non-player transactions (transactions that are inside an in-game economy, outside an in-game economy, backed by virtual currency, etc.) supported by an electronic game. In various embodiments, the non-player transactions may assist and/or hinder progress of a player of the electronic game, as noted further herein. As various examples, the non-player transactions may assist and/or hinder a player's health, a player's points, the absence or the presence of a virtual object which players interact with, etc. The non-player transactions may be, but need not, supported by in-game purchase and/or in-game advertising. As an example, the non-player transactions may be tied to promotions or advertising supported by a venue (such as a retail stores, a restaurant, a shopping or other mall, a stadium, a movie theater, etc.).

In some embodiments, the non-player interactions may comprise instructions to control one or more of the emitters 120, the receivers 125, the player communications devices 130, and the player wearable optical devices 135. The instructions to control the devices in player environment 105 may, but need not, be part of the non-players' participation in the augmented reality gameplay. As an example of instructions to control devices in the player environment 105, the non-player engagement system 195 may activate or deactivate specific emitter(s) 120 and/or specific receiver(s) 125 at specified times or in response to specified events.

The non-player engagement system 195 may instruct the gameplay system 115 to apply, based on non-player interactions, more or less credit to in-game actions associated with specific emitter(s) 120 and/or specific receiver(s) 125. For instance, in embodiments where the emitter 120 corresponds to a gun in an electronic game and the receiver 125 corresponds to a target, the non-player engagement system 195 may instruct the gameplay system 115 to enhance or reduce the power of shots fired by the gun in the electronic game. The non-player engagement system 195 may also instruct the gameplay system 115 to add ammunition to the gun in the electronic game, take away ammunition from the gun, deactivate the gun for a specified time, in response to a specified event, etc. As another example, in embodiments where the emitter 120 corresponds to a sword in an electronic game and the receiver 125 corresponds to armor in the electronic game, the non-player engagement system 195 may instruct the gameplay system 115 to enhance or decrease the power of the sword and/or the shield for a specified time, in response to specified events, etc. In embodiments where the emitter 120 corresponds to a magic wand in an electronic game, the non-player engagement system 195 may instruct the gameplay system 115 to allow and/or disallow specified magical actions the wand is capable of performing in the electronic game. In embodiments where the receiver 125 corresponds to an item in a scavenger hunt game, the non-player engagement system 195 may instruct the gameplay system 115 to activate or deactivate the receiver 125 for a specified time, in response to specified events, etc. It is noted numerous other implementations are possible without departing from the scope and substance of the inventive concepts described herein.

### Example Emitter

FIG. 2 depicts an example of an emitter 120, according to some embodiments. The emitter 120 may include a communications interface module 205, a emitter interaction mechanism 210, a speaker 215, a short-range infrared transmitter 220, a long-range infrared transmitter 225, a beam encoder module 230, and a controller 235. The emitter 120 may include sensors and/or components not identified explicitly in FIG. 2.

The communications interface module 205 may facilitate communications between the emitter 120 and the player communications device 130. In an embodiment, the communications interface module 205 facilitates pairing between the emitter 120 and the player communications device 130. In various embodiments, the communications interface module 205 may be configured as a Bluetooth® pairing module that allows the emitter 120 to be wirelessly coupled to the player communications device 130. The communications interface module 205 may also include any wireless or wired network hardware and/or software in various embodiments. The communications interface module 205 may receive instructions from the controller 235.

The emitter interaction mechanism 210 may allow a player to initiate an action. In some embodiments, the emitter interaction mechanism 210 may correspond to a trigger of a gun. The emitter interaction mechanism 210 may also correspond to a portion (e.g., a blade portion) of a sword or a grenade, depending on a type of weapon the emitter 120 is intended to model. The emitter interaction mechanism 210 may also correspond to a portion of a metal detector for a scavenger-hunt game. The emitter interaction mechanism 210 may provide a signal to the controller 235 when an action has been initiated.

The speaker 215 may provide an audible sound. In various embodiments, the speaker 215 may provide sounds related to sensor-based mobile gameplay when the emitter interaction mechanism 210 has been activated. The sound may correspond to the nature of the action initiated. For instance, the speaker 215 may provide sounds similar to the shooting of a gun, the clash of a sword on armor, or the explosion of a grenade. In various embodiments, the speaker 215 may provide in-game information such as in-game sounds, story narration, clues, and/or other information to enhance gameplay experiences. The speaker 215 may receive instructions from the controller 235.

The short-range infrared transmitter 220 and the long-range infrared transmitter 225 may each emit an infrared signal corresponding to an emitter signal. The short-range infrared transmitter 220 and the long-range infrared transmitter 225 may have different ranges, or may have partially overlapping ranges. The short-range infrared transmitter 220 and the long-range infrared transmitter 225 may provide infrared signals in response to the emitter interaction mechanism 210. The short-range infrared transmitter 220 and the long-range infrared transmitter 225 may receive instructions from the controller 235. It is noted that one or more of the short-range infrared transmitter 220 and the long-range infrared transmitter 225 may be replaced or augmented by non-infrared technologies, such as other wireless technologies and/or NFC technologies, without departing from the scope and substance of the inventive concepts herein.

The beam encoder module 230 may encode emitter signals with an identifier corresponding to the identity of the emitter 120. In some embodiments, the beam encoder module 230 may receive a unique identifier of the emitter 120 from the controller 235. The beam encoder may further encode emitter signals with the unique identifier. Encoding may involve frequency selection frequency modulation of the emitter signal, or encoding particular sequences of data into the emitter signal from the emitter 120. The beam encoder module 230 may provide the code to the short-range infrared transmitter 220 and/or the long-range infrared transmitter 225.

The controller 235 may control other components of the emitter 120. The controller 235 may provide instructions to one or more of the communications interface module 205, the emitter interaction mechanism 210, the speaker 215, the short-range infrared transmitter 220, the long-range infrared transmitter 225, and the beam encoder module 230. In some embodiments, the controller 235 may include a processor and memory. The controller 235 may include a mobile device processor and static or dynamic memory.

### Example Receiver

FIG. 3 depicts an example of a receiver 125, according to some embodiments. The receiver 125 may include a communications interface module 305, an infrared receiver 310, a beam decoder 315, a vibrator 320, a speaker 325, Light Emitting Diodes (LEDs) 330, and a controller 335. The receiver 125 may include sensors and/or components not identified explicitly in FIG. 3.

The communications interface module 305 may facilitate communications between the receiver 125 and the player communications device 130. In an embodiment, the communications interface module 305 facilitates pairing between the receiver 125 and the player communications device 130. In various embodiments, the communications interface module 305 may be configured as a Bluetooth® pairing module that allows the receiver 125 to be wirelessly coupled to the player communications device 130. The communications interface module 305 may also include any wireless or wired network hardware and/or software in various embodiments. The communications interface module 305 may receive instructions from the controller 335.

The infrared receiver 310 may receive infrared signals. In various embodiments, the infrared receiver 310 may be implemented as an electromagnetic receiver that filters out frequencies other than infrared signals. It is noted the infrared receiver 310 may be replaced or augmented by non-infrared technologies, such as other wireless technologies and/or NFC technologies, without departing from the scope and substance of the inventive concepts herein. The infrared receiver 310 may provide received infrared signals to the beam decoder 315 and/or other modules of the receiver 125.

The beam decoder 315 may decode received emitter signals. More specifically, the beam decoder 315 may identify an emitter identifier encoded in emitter signals received by the infrared receiver 310. In various embodiments, the beam decoder 315 may receive instructions from the controller 335.

The vibrator 320 may cause the receiver 125 to physically move. The speaker 325 may make an audible noise. The LEDs 330 may cause all or a part of the receiver 125 to appear to light up. In various embodiments, the vibrator 320, the speaker 325, and the LEDs 330 may receive instructions from the controller 335 to be activated when the infrared receiver 310 has received an emitter signal that indicates a gameplay action by an emitter.

The controller 335 may control other components of the receiver 125. The controller 235 may provide instructions to one or more of the communications interface module 305, the infrared receiver 310, the beam decoder 315, the vibrator 320, the speaker 325, and the Light Emitting Diodes (LEDs) 330. The controller 335 may include a processor (e.g., a mobile device processor) and memory (e.g., static or dynamic memory).

### Example Communications Device

FIG. 4 depicts an example of a communications device 400, according to some embodiments. The communications device 400 may include a pairing management module 405, a user interface module 410, an emitter interface module 415, a receiver interface module 420, a gameplay cloud interface module 425, a gameplay memory datastore 430, a wearable optical device interface module 435, a communications device interaction recognition module 440, and a local environment determination module 445. One or more of the pairing management module 405, the user interface module 410, the emitter interface module 415, the receiver interface module 420, the gameplay cloud interface module 425, the gameplay memory datastore 430, the wearable optical device interface module 435, the communications device interaction recognition module 440, and the local environment determination module 445 may include hardware and/or software, in various embodiments. One or more of the pairing management module 405, the user interface module 410, the emitter interface module 415, the receiver interface module 420, the gameplay cloud interface module 425, the gameplay memory datastore 430, the wearable optical device interface module 435, the communications device interaction recognition module 440, and the local environment determination module 445 may be coupled to one another or to components external to the communications device 400.

The pairing management module 405 may configure the communications device 400 to be paired with other devices. In various embodiments, the pairing management module 405 may include a Bluetooth® pairing module that facilitates wireless pairing with other devices. The pairing management module 405 may also perform other types of pairing to couple the communications device 400 to other devices without departing from the scope and the substance of the inventive concepts herein. In embodiments, the pairing management module 405 may facilitate pairing with one or more of the emitter 120, the receiver 125, and the player wearable optical device 135.

The user interface module 410 may facilitate user interaction with the communications device 400. In some embodiments, the user interface module 410 may configure a display of the communications device 400 to provide one or more user interface elements with which a player can interact. The user interface module 410 may further provide scenes, views, perspectives, and other attributes of gameplay to a user. The user interface module 410 may also facilitate user input to the communications device 400. The user interface module 410 may include video processing hardware and/or software, in various embodiments.

The emitter interface module 415 may facilitate interfacing with the emitter 120. In various embodiments, the emitter interface module 415 may receive and/or provide data to the emitter 120. The receiver interface module 420 may facilitate interfacing with the receiver 125. In various embodiments, the receiver interface module 420 may receive and/or provide data to the receiver 125.

The gameplay cloud interface module 425 may facilitate coupling the communications device 400 to the gameplay system 115. In various embodiments, the gameplay cloud interface module 425 may receive and/or provide data to the gameplay system 115. The gameplay cloud interface module 425 may, in various embodiments, provide player information (e.g., player information related to the emitter 120) to the gameplay system 115. The gameplay cloud interface module 425 may incorporate network interface hardware and/or software to facilitate interfacing with the network 110.

The wearable optical device interface module 435 may facilitate interfacing with the player wearable optical device 135. In various embodiments, the wearable optical device interface module 435 may receive and/or provide data to the player wearable optical device 135.

The communications device interaction recognition module 440 may receive user interactions. In some embodiments, the communications device interaction recognition module 440 receives and/or identifies gestures or other user input to the communications device 400. As examples, the communications device interaction recognition module 440 may receive and/or identify switching weapons or reloading a weapon using radio buttons on the graphical user interface of the communications device 400.

The local environment determination module 445 may provide data (such as a location of the communications device 400) that used to recognize parameters of the physical world around the communications device 400. In some embodiments, the local environment determination module 445 includes a GPS receiver that identifies GPS coordinates of the communications device 400. In embodiments, the local environment determination module 445 may include hardware and/or software that interface with physical sensors on receiver(s) 125 and allows determination of location based on proximity and/or other physical parameters to the receiver(s) 125. In some embodiments, the local environment determination module 445 includes BLE hardware and/or software that provides a location of the communications device 400 based on proximity to locational beacons.

### Example Wearable Optical Device

FIG. 5 depicts an example of a wearable optical device 500, according to some embodiments. The wearable optical device 500 may include a communications interface module 505, a display rendering module 510, an eye movement recognition module 515, a touch input recognition module 520, a voice input recognition module 525, an emitter interaction recognition module 530, a motion detection module 535, and a controller 540. One or more of the communications interface module 505, the display rendering module 510, the eye movement recognition module 515, the touch input recognition module 520, the voice input recognition module 525, the emitter interaction recognition module 530, the motion detection module 535, and the controller 540 may include hardware and/or software, in various embodiments. One or more of the communications interface module 505, the display rendering module 510, the eye movement recognition module 515, the touch input recognition module 520, the voice input recognition module 525, the emitter interaction recognition module 530, the motion detection module 535, and the controller 540 may be coupled to one another or to components external to the wearable optical device 500.

The communications interface module 505 may facilitate communications between the wearable optical device 500 and the player communications device 130. In an embodiment, the communications interface module 505 facilitates pairing between the wearable optical device 500 and the player communications device 130. In various embodiments, the communications interface module 505 may be configured as a Bluetooth® pairing module that allows the wearable optical device 500 to be wirelessly coupled to the player communications device 130. The communications interface module 505 may also include any wireless or wired network hardware and/or software in various embodiments. The communications interface module 505 may receive instructions from the controller 540.

The display rendering module 510 may render virtual objects onto a display of the wearable optical device 500. In some implementations, the display rendering module 510 addresses pixels and/or other portions of a display of the wearable optical device 500 to show virtual objects.

The eye movement recognition module 515 may track eye movements of a user of the wearable optical device 500. In some implementations, the eye movement recognition module 515 recognizes commands, actions, etc. based on eye movements.

The touch input recognition module 520 may recognize touch input by a user of the wearable optical device 500. In various implementations, the touch input recognition module 520 recognizes commands, actions, etc. based on touches (e.g., touches to various external surfaces of the wearable optical device 500).

The voice input recognition module 525 may recognize voice input by a user of the wearable optical device 500. In various implementations, the voice input recognition module 525 recognizes commands, actions, etc. based on natural language commands provided by the user of the wearable optical device 500.

The emitter interaction recognition module 530 may recognize actions based on touches, motions, etc. of the emitter 120. In some implementations, the emitter interaction recognition module 530 recognizes commands, actions, etc. based on touches, motions, etc. of the emitter 120.

The motion detection module 535 may recognize motion (pitch, roll, yaw, tilts, translations, any motion observed by an accelerometer or gyroscope, etc.) of the wearable optical device 500. In various implementations, the motion detection module 535 recognizes commands, actions, etc. based on how the user of the wearable optical device 500 moves the wearable optical device 500.

The controller 540 may control other components of the wearable optical device 500. The controller 540 may provide instructions to one or more of the communications interface module 505, the display rendering module 510, the eye movement recognition module 515, the touch input recognition module 520, the voice input recognition module 525, the emitter interaction recognition module 530, and the motion detection module 535. The controller 540 may include a processor (e.g., a mobile device processor) and memory (e.g., static or dynamic memory).

### Example Gameplay System

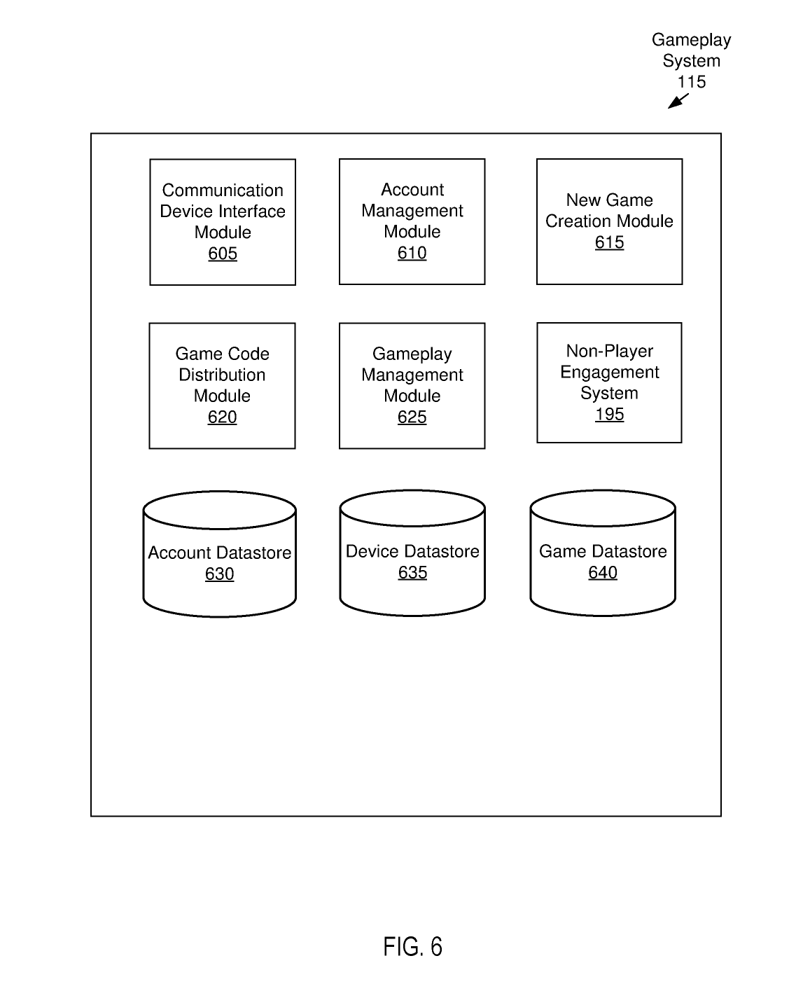

FIG. 6 shows an example of a gameplay system 115, according to some embodiments. The gameplay system 115 may include a mobile device interface module 605, an account management module 610, a new game creation module 615, a game code distribution module 620, a gameplay management module 625, an account datastore 630, a device datastore 635, and a game datastore 640. One or more of the mobile device interface module 605, the account management module 610, the new game creation module 615, the game code distribution module 620, the gameplay management module 625, the non-player engagement system 195, the account datastore 630, the device datastore 635, and the game datastore 640 may include hardware and/or software. One or more of the mobile device interface module 605, the account management module 610, the new game creation module 615, the game code distribution module 620, the gameplay management module 625, the non-player engagement system 195, the account datastore 630, the device datastore 635, and the game datastore 640 may be coupled to one another or to components external to the gameplay system 115.

The mobile device interface module 605 may facilitate coupling the gameplay system 115 to the player communications device 130. In various embodiments, the mobile device interface module 605 may receive and/or provide data to the player communications device 130. The mobile device interface module 605 may incorporate network interface hardware and/or software to facilitate interfacing with the network 110.

The account management module 610 may manage accounts for players of sensor-based mobile gameplay. The account management module 610 may manage information such as players' points, usernames, and levels. The account management module 610 may also manage players' relationships with each other. For example, the account management module 610 may manage actions specific players have taken with respect to other players. In various embodiments, the account management module 610 may manage player accounts based on information about players stored in the account datastore 630. The account management module 610 may also manage player accounts based on information about devices stored in the device datastore 635.

The new game creation module 615 may facilitate creation of new games. In various embodiments, the new game creation module 615 may receive instructions to create a new game from a player. The instructions may include identifiers of all players who are invited to play the game. In response to the instructions, the new game creation module 615 may obtain a game instance from the game datastore 640, and place the game instance into memory of the gameplay system 115. The new game creation module 615 may further associate the instance of the game with the identifiers of the players invited to play the game. In various embodiments, the new game creation module 615 may create a game code for the instance of the new game. The new game creation module 615 may provide the game code to the game code distribution module 620.

The game code distribution module 620 may distribute the game code to all players who have been invited to play the instance of the new game. The game code distribution module 620 may receive from the new game creation module 615 a game code for a new game. In various embodiments, the game code distribution module 620 may further obtain, from the account management module 610 or otherwise, contact information of each of the players who were invited to play the game. The game code distribution module 620 may provide the game code for a new game to the contact information of each of the players who were invited to play the game.

The gameplay management module 625 may manage aspects of gameplay related to a new or existing augmented reality electronic game. In various embodiments, the gameplay management module 625 may identify actions one player has taken with respect to another player. For example, the gameplay management module 625 may identify whether a receiver of a second player has registered an in-game action from an emitter of a first player. The gameplay management module 625 may also identify movements or evasive actions on the part of the second player. In some embodiments, the gameplay management module 625 may associate points with specific actions by players of the game. The gameplay management module 625 may also manage lives, levels, and coordinate group gameplay between players of the game. In some embodiments, the gameplay management module 625 may manage a storyline underlying the gameplay. For example, in a first-person shooting game, the gameplay management module 625 may manage a storyline associated with players entering into combat with one another. In various embodiments, the gameplay management module 625 may support messaging between players. In embodiments, the gameplay management module 625 may further render scenes, views, perspectives, and other attributes of gameplay on the user interface module 410, shown in FIG. 4.

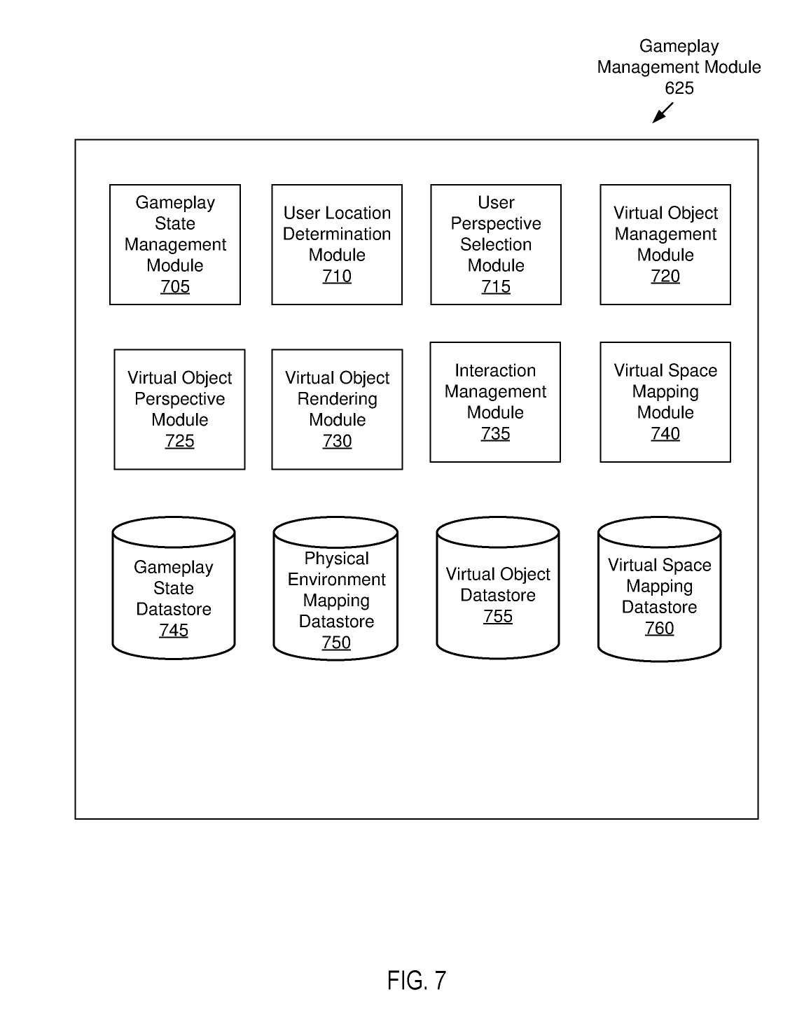

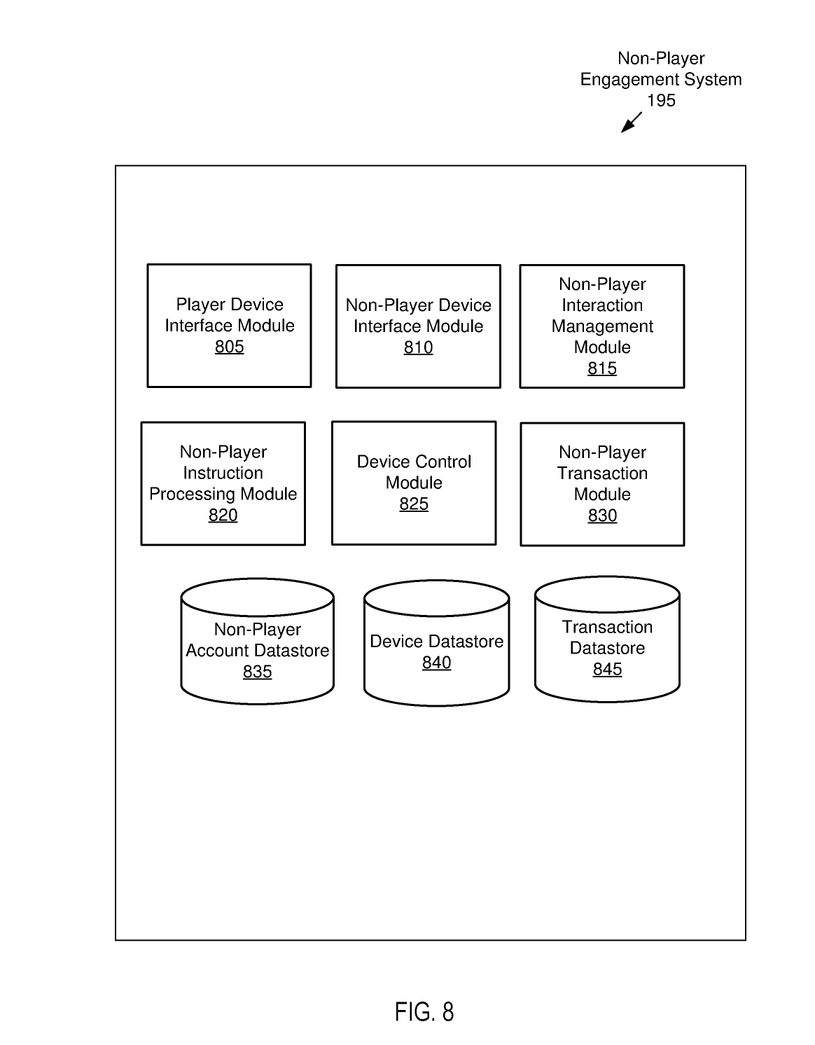

In various embodiments, the gameplay management module 625 manages display of virtual objects in the player wearable optical device 135 as part of augmented reality electronic gaming. To this end, the gameplay management module 625 may select virtual objects for a game player based on one or more factors (a state of gameplay, the location of a game player in the physical world, etc.). The gameplay management module 625 may identify one or more perspectives a game player is likely to have with respect to a virtual object, and may render those perspectives of the virtual object on the player wearable optical device 135 associated with that game player. The gameplay management module 625 may further receive interactions from the game player with respect to the virtual object. Examples of interactions may include actions using the emitter 120 (activity related to the emitter interaction mechanism 210, etc.), actions using the player communications device 130 (activity related to the player communications device 130, etc.), and actions using the player wearable optical device 135 (eye movements, touch inputs, voice inputs, movement(s), etc.). In various implementations, the gameplay management module 625 registers actions against virtual objects by modifying the state of the virtual objects. FIG. 7 shows the gameplay management module 625 in greater detail. The non-player engagement system 195 facilitates non-player engagement with gameplay. FIG. 8 shows the non-player engagement system 195 in greater detail.

The account datastore 630 may store information related to player accounts. The account datastore 630 may store information such as players' points, usernames, and players' relationships with each other, actions specific players have taken with respect to other players, and other information. The device datastore 635 may store devices that have participated in gameplay. The game datastore 640 may store game instances. In various embodiments, game instances are implemented as data structures in the game datastore 640 that can be instantiated and placed into memory by the new game creation module 615.

### Example Gameplay Management System

FIG. 7 depicts an example of a gameplay management module 625, according to some embodiments. The gameplay management module 625 may include a gameplay state management module 705, a user location determination module 710, a user perspective selection module 715, a virtual object management module 720, a virtual object perspective module 725, a virtual object rendering module 730, an interaction management module 735, a virtual space mapping module 740, a gameplay state datastore 745, a physical environment mapping datastore 750, a virtual object datastore 755, and a virtual space mapping datastore 760.

One or more of the gameplay state management module 705, the user location determination module 710, the user perspective selection module 715, the virtual object management module 720, the virtual object perspective module 725, the virtual object rendering module 730, the interaction management module 735, the virtual space mapping module 740, the gameplay state datastore 745, the physical environment mapping datastore 750, the virtual object datastore 755, and the virtual space mapping datastore 760 may include hardware and/or software. One or more of the gameplay state management module 705, the user location determination module 710, the user perspective selection module 715, the virtual object management module 720, the virtual object perspective module 725, the virtual object rendering module 730, the interaction management module 735, the virtual space mapping module 740, the gameplay state datastore 745, the physical environment mapping datastore 750, the virtual object datastore 755, and the virtual space mapping datastore 760 may be coupled to one another or to components external to the gameplay management module 625.

The gameplay state management module 705 may manage state(s) of augmented reality electronic gameplay. In various implementations, the gameplay state management module 705 retrieves, modifies, updates, etc. one or more states of augmented reality electronic games in the gameplay state datastore 745. The gameplay state management module 705 may receive instructions from the virtual object rendering module 730 to modify gameplay state(s) based on virtual objects, and/or the interaction management module 735 to modify gameplay state(s) based on interactions with the emitter 120, the player communications device 130, and the player wearable optical device 135.

The user location determination module 710 may identify locations of game players. In some embodiments, the user location determination module 710 gathers GPS coordinates of game players from GPS devices on emitter(s) 120, receiver(s) 125, and/or communications device(s) 130. In various embodiments, the user location determination module 710 may determine the locations of game players based on the orientations of receiver(s) 125 and/or communications device(s) 130 in relation to receiver(s) 125 in a geo-fenced region (e.g., by determining the proximity of an emitter 120 or a player communications device 130 to a receiver 125 in a geo-fenced region). In some embodiments, the user location determination module 710 receives information from beacons (e.g., BLE beacons) on emitter(s) 120 and/or communications device(s) 130 to determine locations of game players. It is noted the user location determination module 710 may determine location of game players using some combination of the techniques herein or using techniques not described explicitly herein.

The user perspective selection module 715 may select one or more perspectives game players may have of the physical world. In various embodiments, the user perspective selection module 715 gather s information about the physical world from the physical environment mapping datastore 750. The user perspective selection module 715 may further identify a game player's distances, orientations, etc. with respect to obstacles, contours, etc. in the game player's physical environment. In various embodiments, the user perspective selection module 715 may provide information about game players' perspectives regarding a physical environment to other modules.

The virtual object management module 720 may select virtual objects to be displayed on the communications device(s) 130 and/or the wearable optical device(s) 135. In some embodiments, the virtual object management module 720 gathers relevant virtual objects from the virtual object datastore 755 based on gameplay state(s) and/or physical location(s) of game players. As an example of operation, the virtual object management module 720 may gather specific virtual objects for game players who have reached specific game levels, accrued specific amounts of game points, and/or confronted specific virtual characters or virtual items. For instance, the virtual object management module 720 may gather a virtual object containing a representation of a dragon or other mythical creature in an augmented reality electronic fantasy game in which a game player has passed a certain game level. As another example of operation, the virtual object management module 720 may gather virtual objects related to specific physical locations or environments of game players. For instance, in an augmented reality electronic game in which game players are in the desert, the virtual object management module 720 may select clay targets to display on the wearable optical device(s) 135 of game players.

The virtual object perspective module 725 may select perspectives of virtual objects for rendering. In some embodiments, the selection of perspective may depend on the angles, distances, and orientations of game player(s) from a projection of a virtual object. As an example of operation, the virtual object perspective module 725 may determine that the virtual object management module 720 selected a virtual object that projects an image of a fifty foot dragon approximately twenty feet in the air above two game players. To continue this example, the player wearable optical device 135 of the first game player may need to view the right side of the dragon, while the player wearable optical device 135 of the second game player may need to view the front of the dragon. The virtual object perspective module 725 may identify, based on properties of the CAD file corresponding to the virtual object, a first perspective corresponding to the right side of the dragon, and a second perspective corresponding to the front of the dragon. These perspectives may form the basis of rendering, as discussed further herein.

The virtual object rendering module 730 may render virtual objects in the communications device(s) 130 and/or the wearable optical device(s) 135. In some implementations, the virtual object rendering module 730 may receive a virtual object from the virtual object management module 720, and receive a perspective of that virtual object from the virtual object perspective module 725. The virtual object rendering module 730 may instruct relevant displays on the communications device(s) 130 and/or the wearable optical device(s) 135 to display the virtual object from the selected perspective.

The interaction management module 735 may detect interactions by game players. In some embodiments, the interaction management module 735 may monitor the emitter interaction mechanism 210 on the emitter 120 for actions taken in response to a virtual object. Examples of such actions may correspond to shooting of a gun, swinging of a sword, making a motion corresponding to casting a spell using a wand, throwing a grenade, and picking up an item during a scavenger hunt. In various embodiments, the interaction management module 735 may monitor gestures or other input on the player communications device 130. Examples of such actions include switching weapons or reloading a weapon using radio buttons on the graphical user interface of the player communications device 130. Further, in some embodiments, the interaction management module 735 may monitor actions on the player wearable optical device 135. Examples of such actions include voice commands, touch gestures on hardware on the player wearable optical device 135, eye movements that are tracked by the player wearable optical device 135, and motions detected by the player wearable optical device 135 (pitch, roll, yaw, tilts, translations, any motion observed by an accelerometer or gyroscope, etc.). The interaction management module 735 may provide information related to detected interactions to other modules, such as the gameplay state management module 705.

The virtual space mapping module 740 may map models of user interactions and virtual objects into a virtual space. The virtual space may be indexed by a relevant coordinate system (e.g., a Cartesian coordinate system) that specifies the distance and direction models of user interactions and/or virtual objects are projected away from a game player. The maps of virtual spaces may be gathered from the virtual space mapping datastore 760. In some embodiments, the virtual space mapping module 740 may identify one or more areas in a virtual space that corresponds to models of user interactions and/or virtual objects. The virtual space mapping module 740 may further determine whether one area in a virtual space overlaps with another area in the virtual space.

The gameplay state datastore 745 may store the various states of one or more augmented reality electronic games. In some embodiments, the gameplay state datastore 745 stores sequences of actions, levels, triggers, conditions, etc. that may form the basis of the states of augmented reality electronic games. The states of augmented reality electronic games may be updated, modified, etc. as game players progress through the augmented reality electronic games. As an example, the states of augmented reality electronic games may change as the gameplay state management module 705 receives information about user actions with virtual objects, as discussed further herein.

The physical environment mapping datastore 750 may store files that have information related to one or more physical environments. In some embodiments, the files provide information about what the physical world around game players looks like. As an example, the files may provide information about open areas, obstacles, and contours of physical items within a particular physical environment. In some embodiments, the physical environment mapping datastore 750 gathers relevant geographical information from geographical databases, such as map databases, databases of building plans, etc. In various embodiments, the physical environment mapping datastore 750 gathers geographical information about game players' environments from meshes, such as predetermined meshes that provide information about open areas, obstacles, and contours of physical items within a particular physical environment as well as meshes generated using cameras on wearable optical device(s) 135.

The virtual object datastore 755 may store files that represent virtual objects. In various embodiments, the virtual object datastore 755 stores libraries of CAD files (e.g., Unity® files) that represent virtual objects. The CAD files may further specify how virtual objects appear from various perspectives, including various angles, distances, and orientations. In some embodiments, the virtual object datastore 755 obtains the CAD files from external sources, such as third-party illustrators and/or publishers. Further, representation of virtual objects in the virtual object datastore 755 may relate to a particular augmented reality electronic game or genre of augmented reality electronic games (e.g., the virtual object datastore 755 may store representation of fantasy creatures for an augmented reality electronic game having fantasy themes, representations of combat vehicles for a augmented reality electronic game having a combat theme, representations of inanimate objects for a augmented reality electronic game implementing a scavenger hunt, etc.).

The virtual space mapping datastore 760 may store maps of the virtual spaces used to project models of user interactions and virtual objects. In various implementations, the virtual spaces in the virtual space mapping datastore 760 are indexed by a relevant coordinate system (e.g., a Cartesian coordinate system) that specifies the distance and direction models of user interactions and/or virtual objects are projected away from a game player. As an example, the virtual space mapping datastore 760 may store a map of a virtual space that represents all items within the field of view of a game player. In this example, the map may contain a virtual object of a dragon that is represented about fifty feet directly east of the game player at a height of fifty feet. The map may further contain objects of user interactions with the dragon, such as objects that represent a specified number of shots (and the directions of such shots) the game player has taken at the object using an emitter 120.

### Example Non-Player Engagement System

### Example System Architecture

FIG. 8 depicts an example of a non-player engagement system 195, according to some embodiments. The non-player engagement system 195 may include a player device interface module 805, a non-player device interface module 810, a non-player interaction management module 815, a non-player instruction processing module 820, a device control module 825, a non-player transaction module 830, a non-player account datastore 835, a device datastore 840, and a transaction datastore 845.

One or more of the player device interface module 805, the non-player device interface module 810, the non-player interaction management module 815, the non-player instruction processing module 820, the device control module 825, a non-player transaction module 830, the non-player account datastore 835, the device datastore 840, and the transaction datastore 845 may include hardware and/or software. One or more of the player device interface module 805, the non-player device interface module 810, the non-player interaction management module 815, the non-player instruction processing module 820, the device control module 825, a non-player transaction module 830, the non-player account datastore 835, the device datastore 840, and the transaction datastore 845 may be coupled to one another or to modules external to the non-player engagement system 195.

The player device interface module 805 may interface with player devices and/or the gameplay system 115 to monitor actions and/or events related to players. In some embodiments, the actions and/or events provide information related to a physical environment related to an augmented reality game. The player device interface module 805 may be configured to send data to and/or receive data from the emitters 120, the receivers 125, the player communications devices 130, the gameplay system 115, and/or the player wearable optical devices 135. As an example, the player device interface module 805 receive data from one of the emitters 120 when the emitter 120 has connected taken an action against a receiver 125. As another example, the player device interface module 805 receive data from one of the receivers after an emitter 120 has connected taken an action against the receiver 125. In some embodiments, the player device interface module 805 receive data from one of the player communications devices 130, the gameplay system 115, and/or the player wearable optical devices 135 when a player has taken an in-game action that would change a gameplay state of an electronic game.

The player device interface module 805 may receive sensor data from sensors coupled to player devices; the data may be provided directly from the player devices or indirectly through the gameplay system 115. As an example, in some embodiments, the player device interface module 805 may receive depth data from depth cameras coupled to one or more of the emitters 120, the receivers 125, the player communications devices 130, and/or the player wearable optical devices 135. The depth data may comprise a mesh of the physical environment around a player. As another example, the player device interface module 805 may receive positional tracking information from positional tracking sensors coupled to one or more of the emitters 120, the receivers 125, the player communications devices 130 and/or the player wearable optical devices 135. The positional tracking information may comprise GPS information from a GPS sensor, SLAM data from a SLAM sensor, BLE data from a BLE sensor, etc. The positional tracking information may comprise information from one or more positional markets (e.g., markers in a geofenced environment) gathered from positional tracking sensors. In various embodiments, the player device interface module 805 may use the sensor data to identify physical attributes of one or more physical objects in the player environment.

The non-player device interface module 810 may send data to and receive data from non-player devices. The data to/from the non-player devices may provide information about an augmented reality electronic game to non-players. In some embodiments, the information about the augmented reality electronic game comprises an augmented field of view that a player of the augmented reality electronic game sees when playing the augmented reality electronic game. The augmented field of view may comprise, in various embodiments, how a player's physical environment looks to the player (e.g., a perspective with virtual objects superimposed over a view of the physical world). In some embodiments, the augmented field of view may comprise solely virtual objects. As an example, the augmented field of view may comprise a virtual map related to the augmented reality video game. In various embodiments, the non-player device interface module 810 is configured to send a streaming video of the augmented field of view to the non-player devices. The streaming video may, but need not, correspond to a live stream of the augmented field of view based on the perspective of the player. The streaming video may contain video data captured by and/or taken from one of the player devices one of the player wearable optical devices 135. The non-player device interface module 810 may also receive non-player interactions from non-player devices (e.g., non-player communications devices 185).

The non-player interaction management module 815 may process non-player interactions from non-players. In various embodiments, the non-player interaction management module 815 receives non-player interactions from the non-player device interface module 810. The non-player interactions may have been captured by one or more of the non-player communications devices 185 and/or one or more of the non-player wearable optical devices 190. In various embodiments, the non-player interactions comprise attempts to engage with a virtual object. As examples, the non-player interactions may comprise actions non-players have taken with regard to a virtual object (e.g., adding, removing, or modifying a virtual object). As further examples, the non-player interactions may comprise introductions of gameplay elements (e.g., new virtual objects, new characters, new plot elements, new levels, or the like) into the augmented reality electronic game.

In some embodiments, the non-player interactions comprise instructions to assist a player with at least a portion of the augmented reality electronic game. For instance, the non-player interactions may comprise instructions to add to the health of a player, add virtual points to an account of the player, add/modify/delete a virtual object to the benefit of the player, modify the plot of the augmented reality electronic game to assist the player, or the like. In various embodiments, the non-player interactions comprise instructions to impede the progress of a player in at least a portion of the augmented reality electronic game. As further examples, the non-player interactions may comprise instructions to take away from the health of a player, reduce virtual points to an account of the player, add/modify/delete a virtual object to the impediment of the player, modify the plot of the augmented reality electronic game to impede the player, etc.

In various embodiments, the non-player interactions comprise instructions to control a sensor in the augmented reality environment (e.g., within the augmented reality gaming system 100). The non-player interactions may comprise instructions by non-players to control an emitter 120 and/or a receiver 125 in the augmented reality gaming system 100. As examples, in a shooting game, the non-player interaction management module 815 may process non-player interactions that comprise instructions to activate or deactivate a specific emitter 120 and/or a specific receiver 125. As further examples, the non-player interaction management module 815 may process non-player interactions to control depth cameras and/or positional sensors coupled to the non-player communications devices 185 and/or the non-player wearable optical devices 190.

In some embodiments, the non-player interactions comprise one or more transactions in an in-game economy of the augmented reality electronic game. The transactions and the in-game economy may be supported by the non-player transaction module 830 and/or other modules herein.

The non-player instruction processing module 820 may provide instructions to the gameplay management module 625 to perform one or more actions based on the non-player interactions. In various embodiments, the non-player instruction processing module 820 receives the non-player interactions from the non-player interaction management module 815, and provides these non-player interactions to the gameplay management module 625 in the form of instructions. The instructions may instruct the gameplay management module 625 to modify a gameplay state or other attributes of an augmented reality electronic game based on the non-player interactions. In various embodiments, the modification of the gameplay state may include creation, modification, deletion, etc. of specific gameplay elements in the augmented reality electronic game. Further, the modification of the gameplay state may include creation, modification, deletion, etc. of specific virtual objects in the augmented reality electronic game.

The device control module 825 may provide instructions to control one or more devices in the augmented reality gaming system 100. As various examples, the device control module 825 may provide instructions to control one or more of the emitters 120, one or more of the receivers 125, and/or one or more of the player wearable optical devices 135. The instructions from the device control module 825 may be based on the non-player instructions provided by the non-player interaction management module 815.

The non-player transaction module 830 may process non-player transactions in non-player interactions. In some embodiments, the non-player transaction module 830 manages an in-game economy of an augmented reality electronic game. An “in-game economy,” as used herein, may refer to an ecosystem of transactions that could include players and/or non-players. Examples of in-game economies include economies that facilitate purchases of virtual items, economies that facilitate transactions between players and/or non-players, fantasy sports leagues including players, economies that allow non-players to bet on actions by players, economies that allow players and/or non-players to purchase in-game items, etc. In some embodiments, the non-player transactions comprise purchases in the in-game economy. Examples of things that may be purchased include: virtual objects, gameplay elements that assist or impede the progress of players in the augmented reality electronic game, and/or gameplay elements that control one or more sensors in the augmented reality gaming system 100. In some embodiments, the non-player transactions may be based on a virtual currency (e.g., in-game currencies digital currencies, BitCoin, eGold, or the like) that have a value in the in-game economy. In various embodiments, the virtual currencies have a value outside the in-game economy.

The non-player account datastore 835 may store information related to non-player accounts. The non-player account datastore 835 may store information such as non-players' points, usernames, and non-players' relationships with each other and/or relationships with players, actions specific non-players have taken with respect to other non-players and/or players, non-players' histories of engagement with electronic games, and other information. The device datastore 840 may store information related to devices in the augmented reality gaming system 100. In various embodiments, the information related the devices are implemented as data structures in the device datastore 840 that can be instantiated and placed into memory by the device control module 825. The transaction datastore 845 may store information related to non-player transactions. In various embodiments, non-player transactions are implemented as data structures in the transaction datastore 845 that can be instantiated and placed into memory by the non-player transaction module 830.

### Example Operation of Non-Player Engagement System

In some embodiments, the non-player engagement system 195 operates to facilitate non-player engagement with the augmented reality gaming system 100. More specifically, the player device interface module 805 may operate to receive gameplay data from one or more of the player devices. As various examples, the player device interface module 805 may operate to receive gameplay data from one or more of the emitters 120, one or more off the receivers 125, one or more of the player communications devices 130, and one or more of the player wearable optical devices 135. The gameplay data may comprise sensor data from one or more of the sensors on the player devices, such as whether an emitter 120, receiver 125, or player communications device 130 has successfully registered an in-game action. The sensor data may comprise locational information taken from depth cameras and/or positional sensors. In some embodiments, the gameplay data comprise a three-dimensional mesh of the contours of the area around one of the player wearable optical devices 135 taken from a depth camera coupled to the player wearable optical device 135.

The non-player device interface module 810 may operate to provide information about the augmented reality electronic game to non-players. To continue the foregoing examples, the non-player device interface module 810 may provide the gameplay data, sensor data, etc. to one or more non-player devices.

The non-player interaction management module 815 may operate to receive non-player interactions from the non-player devices. The non-player interactions may comprise non-player interactions may comprise actions non-players have taken against a virtual object, introductions of gameplay elements into the augmented reality electronic game, instructions to assist a player with at least a portion of the augmented reality electronic game, instructions to impede the progress of a player in at least a portion of the augmented reality electronic game, instructions to control a sensor in the augmented reality gaming system 100, one or more non-player transactions in an in-game economy supported by the augmented reality electronic game, etc. The non-player transactions may have been gathered by the non-player transaction module 830.

The non-player instruction processing module 820 may operate to instruct the gameplay management module 625 to perform one or more actions based on the non-player interactions. The device control module 825 may provide one or more of the player devices (e.g., one or more of the emitters 120, one or more of the receivers 125, one or more of the player communications devices 130, and/or one or more of the player wearable optical devices 135) with instructions to control a sensor thereon.

### Example Flowcharts of Methods of Operation

### Method for Facilitating an AR Electronic Game

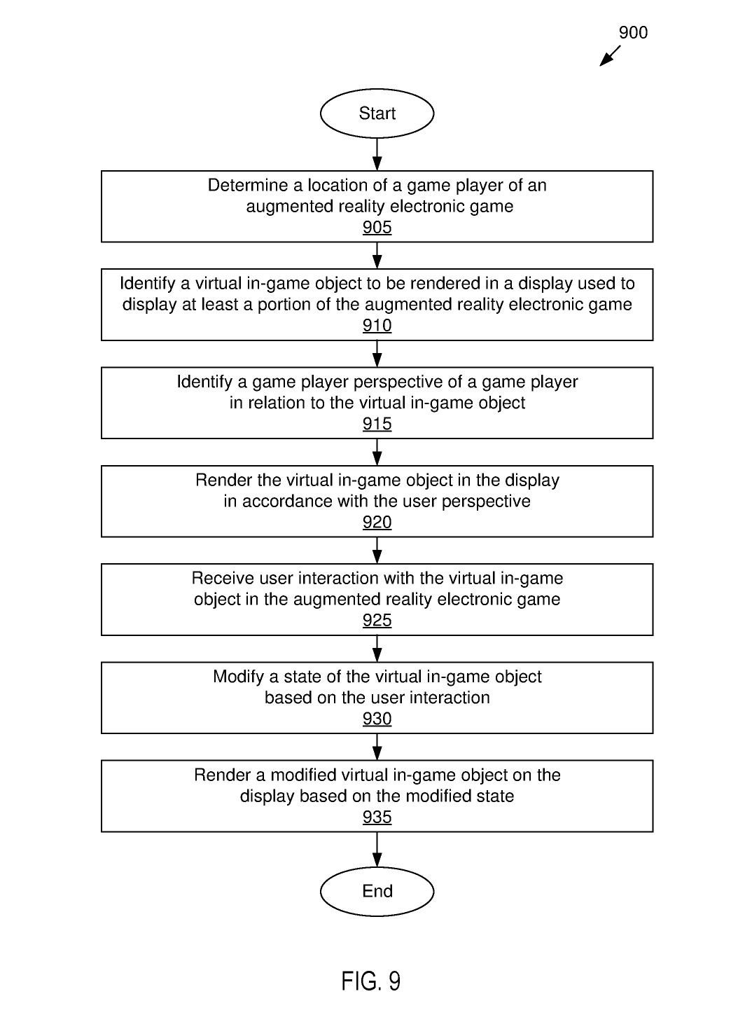

FIG. 9 depicts a flowchart of an example of a method 900 for facilitating an augmented reality electronic game having one or more virtual objects, according to some embodiments. The method 900 is discussed in conjunction with the gameplay management module 625, shown in FIG. 7, and discussed further herein. It is noted that at least some of the operations of the method 900 may be optional, and that the method 900 need not include all of the operations shown in FIG. 9.

At an operation 905, the user location determination module 710 may determine a location of a game player of an augmented reality electronic game. In various implementations, the user location determination module 710 gathers user location information from a GPS transmitter on the player communications device 130, from proximity data between the emitter 120 and the receiver 125, from BLE beacons coupled to the emitter 120, the receiver 125, the player communications device 130, and/or the player wearable optical device 135, and/or other techniques described herein.

At an operation 910, the virtual object management module 720 may identify a virtual in-game object to be rendered in a display used to display at least a portion of the augmented reality electronic game. In various embodiments, the virtual object management module 720 selects virtual in-game objects for the augmented reality electronic game based on one or more factors, such as locations of game players and game states of the augmented reality electronic game. As an example, the virtual object management module 720 may select virtual in-game objects for game players based on specific locations of the game players in the physical world. As another example, the virtual object management module 720 may select virtual in-game objects for game players based on levels/points/etc. the game players have achieved in the augmented reality electronic game.

At an operation 915, the virtual object perspective module 725 may identify a game player perspective of a game player in relation to the virtual in-game object. In some implementations, the virtual object perspective module 725 gathers angles, orientations, distances, etc. from the game player to a projection of the virtual object. The virtual object perspective module 725 may further evaluate, based on parameters of the virtual object, how the virtual object would appear to the display of the game player if the virtual object were projected into the physical environment around the game player.

At an operation 920, the virtual object rendering module 730 may render the virtual in-game object in the display in accordance with the game player perspective. More particularly, the virtual object rendering module 730 may instruct the display to display the virtual in-game object in accordance with the user perspective identified by the virtual object perspective module 725.

At an operation 925, the interaction management module 735 may receive user interaction with the virtual in-game object in the augmented reality electronic game. Interactions may include input to the emitter 120, the player communications device 130, and/or the player wearable optical device 135. The interaction management module 735 may provide this input to the gameplay state management module 705, so that the state of the augmented reality electronic game may be appropriately updated and/or modified.

At an operation 930, the virtual space mapping module 740 may identify a first area in a virtual space corresponding to the virtual in-game object. At an operation 935, the virtual space mapping module 740 may identify a second area in the virtual space corresponding to the virtual in-game object. At an operation 940, the virtual space mapping module 740 may determine whether the second area overlaps the first area.

At an operation 945, the gameplay state management module 705 may modify a state of the virtual in-game object based on the user interaction. The gameplay state management module 705 may provide instructions to modify the virtual in-game object to the other modules of the gameplay management module 625. The modified state of the virtual in-game object may be stored in the virtual object datastore 755.

At an operation 950, the virtual object rendering module 730 may render a modified virtual in-game object on the display based on the modified state. The virtual object rendering module 730 may also instruct the display to display the modified virtual in-game object in accordance with the modifications.

### Method for Rendering a Virtual Object in an AR Electronic Game

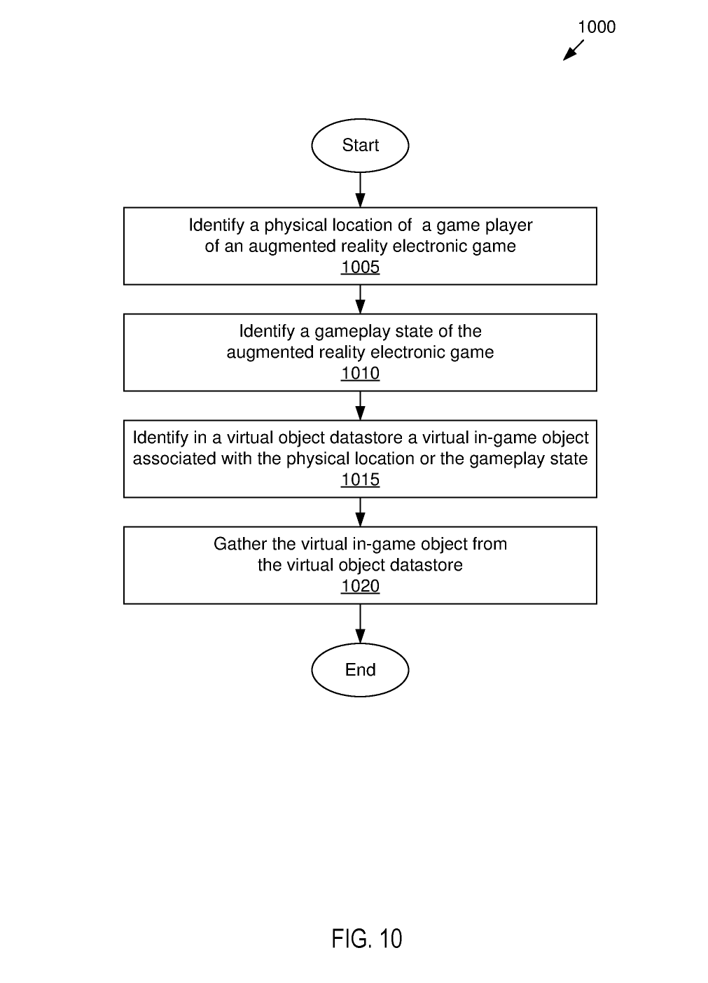

FIG. 10 depicts a flowchart of an example of a method 1000 for rendering a virtual object in an augmented reality electronic game, according to some embodiments. The method 1000 is discussed in conjunction with the gameplay management module 625, shown in FIG. 7, and discussed further herein. It is noted that at least some of the operations of the method 1000 may be optional, and that the method 1000 need not include all of the operations shown in FIG. 10.

At an operation 1005, the user location determination module 710 may identify a physical location of a game player of an augmented reality electronic game. In various implementations, the user location determination module 710 gathers user location information from a GPS transmitter on the player communications device 130, from proximity data between the emitter 120 and the receiver 125, from BLE beacons coupled to the emitter 120, the receiver 125, the player communications device 130, and/or the player wearable optical device 135, and/or other techniques described herein.

At an operation 1010, the gameplay state management module 705 may identify a gameplay state of the augmented reality electronic game. More particularly, the gameplay state management module 705 may identify relevant gameplay levels, points, etc. associated with the gameplay state of the augmented reality electronic game.

At an operation 1015, the virtual object management module 720 may identify in the virtual object datastore 755 a virtual in-game object associated with the physical location or the gameplay state. More particularly, the virtual object management module 720 may select virtual in-game objects that gameplay rules indicate may be projected at the identified location and/or in response to the identified gameplay state of the augmented reality electronic game. At an operation 1020, the virtual object management module 720 may gather the virtual in-game object from the virtual object datastore 755.

### Method for Modifying a State of a Virtual Object in an Augmented Reality Electronic Game

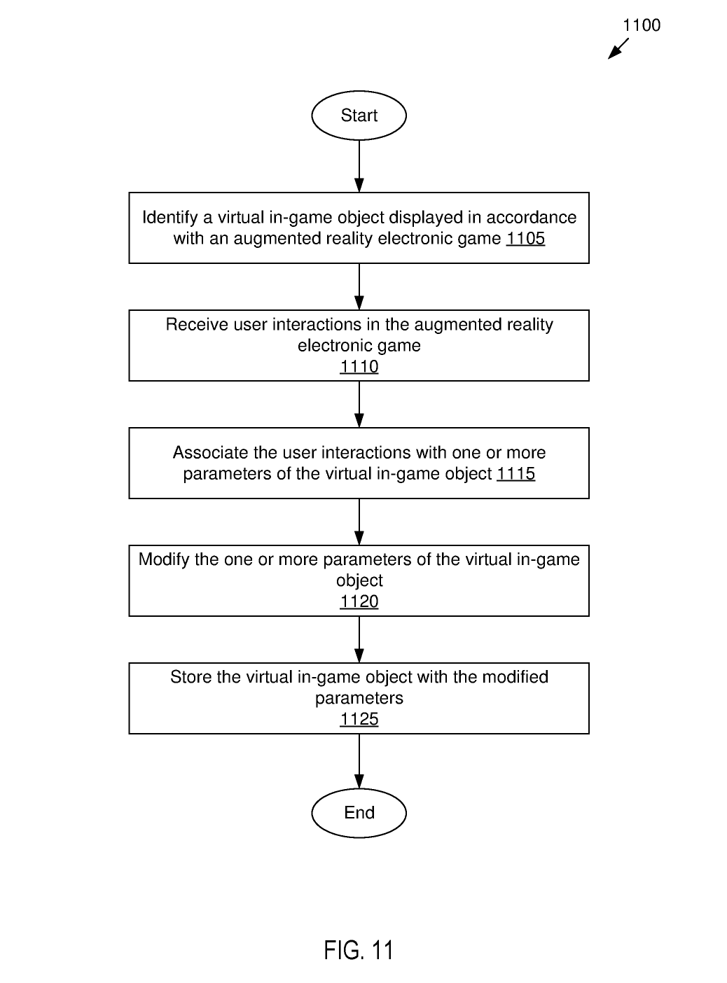

FIG. 11 depicts a flowchart of an example of a method 1100 for modifying a state of a virtual object in an augmented reality electronic game, according to some embodiments. The method 1100 is discussed in conjunction with the gameplay management module 625, shown in FIG. 7, and discussed further herein. It is noted that at least some of the operations of the method 1100 may be optional, and that the method 1100 need not include all of the operations shown in FIG. 11.

At an operation 1105, the virtual object management module 720 may identify a virtual in-game object displayed in accordance with an augmented reality electronic game. More particularly, in some embodiments, the virtual object management module 720 may receive from the gameplay state management module 705 identifiers of virtual in-game objects that have been displayed in an augmented reality electronic game. For instance, the virtual object management module 720 may receive from the gameplay state management module 705 an identifier of a dragon or other virtual object displayed in the player communications device 130 and/or the player wearable optical device 135.

At an operation 1110, the interaction management module 735 may receive user interactions in the augmented reality electronic game. Interactions may include input to the emitter 120, the player communications device 130, and/or the player wearable optical device 135. The interaction management module 735 may provide this input to the gameplay state management module 705, so that the state of the augmented reality electronic game may be appropriately updated and/or modified.

At an operation 1115, the virtual object management module 720 may associate the user interactions with one or more parameters of the virtual in-game object. More particularly, the virtual object management module 720 may determine the extent these user interactions correspond to changes in the virtual in-game object. As an example, if a user uses an emitter 120 to “shoot” at a virtual in-game object that represents a dragon, the virtual object management module 720 may determine where the shots from the emitter 120 would project on the dragon.

At an operation 1120, the virtual object management module 720 may modify the one or more parameters of the virtual in-game object. To continue the foregoing example, if a user uses an emitter 120 to “shoot” at a virtual in-game object that represents a dragon, the virtual object management module 720 may modify portions of an image that represents where the shot would have projected on the dragon. At an operation 1125, the virtual object management module 720 may store the virtual in-game object with the modified parameters.

### Method for Facilitating an AR Electronic Game Having One or More Virtual Objects

FIG. 12 depicts a flowchart of an example of a method 1200 for facilitating an augmented reality electronic game having one or more virtual objects, according to some embodiments. The method 1200 is discussed in conjunction with the gameplay management module 625, shown in FIG. 7, and discussed further herein. It is noted that at least some of the operations of the method 1200 may be optional, and that the method 1200 need not include all of the operations shown in FIG. 12.

FIG. 12 depicts a flowchart of an example of a method 1200 for facilitating an augmented reality electronic game having one or more virtual objects, according to some embodiments. The method 1200 is discussed in conjunction with the gameplay management module 625, shown in FIG. 7, and discussed further herein. It is noted that at least some of the operations of the method 1200 may be optional, and that the method 1200 need not include all of the operations shown in FIG. 12.

At an operation 1205, the user location determination module 710 may determine a location of a game player of an augmented reality electronic shooting game. In various implementations, the user location determination module 710 gathers user location information from a GPS transmitter on the player communications device 130, from proximity data between the emitter 120 and the receiver 125, from BLE beacons coupled to the emitter 120, the receiver 125, the player communications device 130, and/or the player wearable optical device 135, and/or other techniques described herein.

At an operation 1210, the virtual object management module 720 may identify a virtual in-game object corresponding to virtual shooting targets to be rendered in a display used to display at least a portion of the augmented reality electronic game. In various embodiments, the virtual object management module 720 selects virtual in-game objects of virtual shooting targets for the augmented reality electronic game based on one or more factors, such as locations of game players and game states of the augmented reality electronic game. As an example, the virtual object management module 720 may select virtual in-game objects for game players based on specific locations of the game players in the physical world. As another example, the virtual object management module 720 may select virtual in-game objects for game players based on levels/points/etc. the game players have achieved in the augmented reality electronic game.

At an operation 1215, the virtual object perspective module 725 may identify a game player perspective of a game player in relation to the virtual shooting targets. In some implementations, the virtual object perspective module 725 gathers angles, orientations, distances, etc. from the game player to a projection of the virtual object. The virtual object perspective module 725 may further evaluate, based on parameters of the virtual object, how the virtual object would appear to the display of the game player if the virtual object were projected into the physical environment around the game player.

At an operation 1220, the virtual object rendering module 730 may render the virtual shooting targets in the display in accordance with the user perspective. More particularly, the virtual object rendering module 730 may instruct the display to display the virtual in-game object in accordance with the user perspective identified by the virtual object perspective module 725.

At an operation 1225, the interaction management module 735 may receive through the emitter 120 user interaction with the virtual shooting targets in the augmented reality electronic game. For instance, the interaction management module 735 may receive indication that a game player squeezed at trigger of the emitter 120 to shoot at the virtual shooting targets. The interaction management module 735 may provide this input to the gameplay state management module 705, so that the state of the augmented reality electronic game may be appropriately updated and/or modified (e.g., so that the virtual shooting targets can register hits against them).

At an operation 1230, the gameplay state management module 705 may modify an appearance of the virtual shooting targets based on the user interaction. The gameplay state management module 705 may provide instructions to modify the virtual in-game object to the other modules of the gameplay management module 625. The modified state of the virtual in-game object may be stored in the virtual object datastore 755.

At an operation 1235, the virtual object rendering module 730 may render a modified virtual shooting target on the display based on the modified appearance. The virtual object rendering module 730 may also instruct the display to display the modified virtual in-game object in accordance with the modifications. As an example, the virtual object rendering module 730 may render virtual shooting targets that have been hit or have exploded as a result of being shot by the game player in the augmented reality electronic game.

Method for Facilitating Non-Player Engagement with an AR Electronic Gaming System

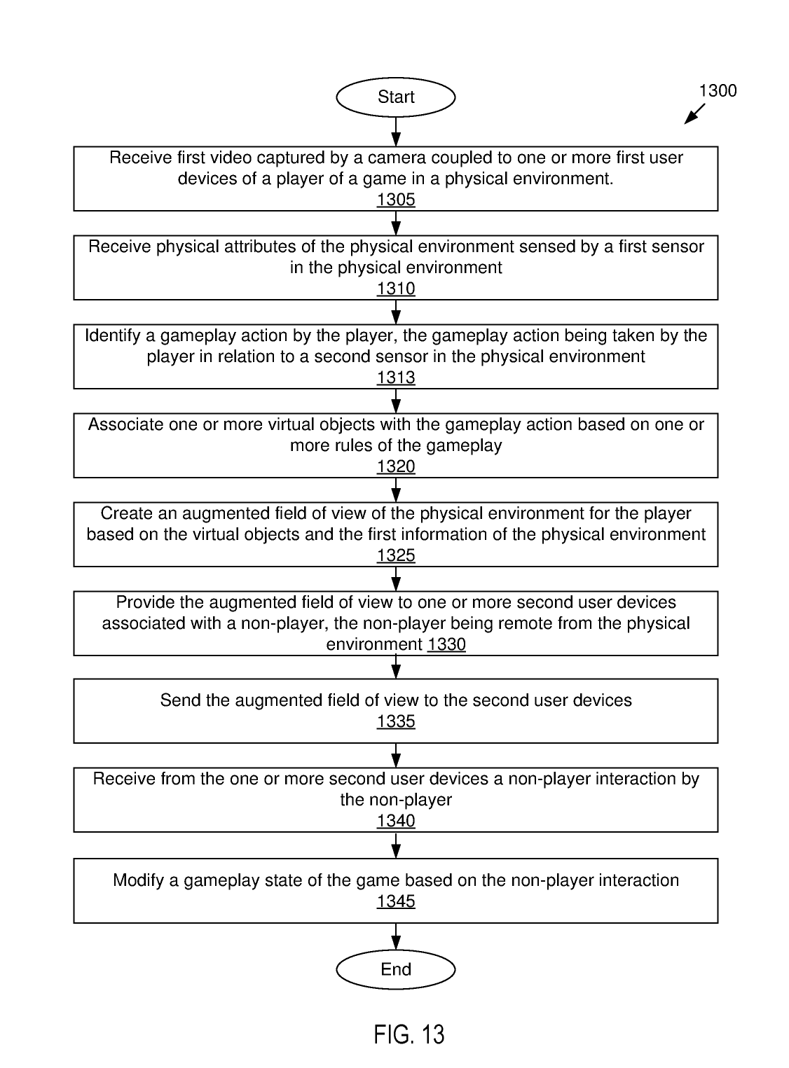

FIG. 13 depicts a flowchart of an example of a method 1300 for facilitating non-player engagement with an augmented reality gaming system, according to some embodiments. The method 1300 is discussed in conjunction with the non-player engagement system 195, shown in FIGS. 6, 7, and/or 8, and discussed further herein. It is noted that at least some of the operations of the method 1300 may be optional, and that the method 1300 need not include all of the operations shown in FIG. 13.

At an operation 1305, the player device interface module 805 receives first video captured by a camera coupled to one or more first user devices of a player of a game in a physical environment. More specifically, the player device interface module 805 may receive video captured by one of the player wearable optical devices 135. The video may comprise a live or pre-recorded video of a relevant physical environment in which an augmented reality game is occurring or will occur. In some embodiments, the video corresponds to a view of a player of the augmented reality gaming system 100. It is noted that the player device interface module 805 may receive still images or bursts of still images in some embodiments.

At an operation 1310, the player device interface module 805 receives physical attributes of the physical environment sensed by a first sensor in the physical environment. In various embodiments, the player device interface module 805 receives sensor data from one or more sensors in the augmented reality gaming system 100. Examples of sensor data that may be received include data from sensors on emitters 120, receivers 125, player communications devices 130, and player wearable optical devices 135. In some embodiments, the sensor data comprises one or more of data from positional sensors and data from depth cameras coupled to player wearable optical devices 135.

At an operation 1315, the gameplay system 115 identifies a gameplay action by the player, the gameplay action being taken by the player in relation to a second sensor in the physical environment. The gameplay action may comprise any action in an augmented reality electronic game maintained by the gameplay management module 625. At an operation 1320, the gameplay system 115 associates one or more virtual objects with the gameplay action based on one or more rules of the gameplay. At an operation 1325, the gameplay system 115 creates an augmented field of view of the physical environment for the player based on the virtual objects and the first information of the physical environment.

At an operation 1330, the non-player device interface module 810 provides the augmented field of view to one or more second user devices associated with a non-player, the non-player being remote from the physical environment. In some embodiments, the non-player device interface module 810 provides a video stream to a non-player wearable optical device 190. The video stream may, but need not, be a live video stream from the perspective of a player (e.g., the same video that is shown in one of the player wearable optical devices 135). The augmented field of view may comprise virtual objects therein. The augmented field of view may show a virtual map associated with the augmented reality electronic game. It is noted that the augmented field of view may contain other elements as well without departing from the scope and substance of the inventive concepts described herein.

At an operation 1335, the non-player device interface module 810 sends the augmented field of view to the second user devices. In some embodiments, the non-player device interface module 810 provides a non-player communications device 185 and/or a non-player wearable optical device 190 with a streaming video of the augmented field of view.

At an operation 1340, the non-player device interface module 810 receives from the one or more second user devices a non-player interaction by the non-player. The non-player interaction may comprise any or some combination of: an introduction of a gameplay element into the gameplay, a modification of a virtual object, an instruction to assist the player in a game supported by the gameplay, or an instruction to impede the player in the game, an instruction to control a sensor in the augmented reality gaming system 100, and/or a non-player transaction in an in-game economy supported by the augmented reality electronic game. The non-player device interface module 810 may provide the non-player interaction to the non-player interaction management module 815.

At an operation 1345, the gameplay system 115 modifies a gameplay state of the electronic game based on the non-player interaction. More specifically, in some embodiments, the gameplay state management module 705 may modify a gameplay state of the augmented reality electronic game in accordance with the non-player interaction.

### Example Digital Devices

FIG. 14 depicts an example of a digital device 1400, according to some embodiments. The digital device 1400 comprises a processor 1405, a memory system 1410, a storage system 1415, a communication network interface 1420, an Input/output (I/O) interface 1425, a display interface 1430, and a bus 1435. The bus 1435 may be communicatively coupled to the processor 1405, the memory system 1410, the storage system 1415, the communication network interface 1420, the I/O interface 1425, and the display interface 1430.

In some embodiments, the processor 1405 comprises circuitry or any processor capable of processing the executable instructions. The memory system 1410 comprises any memory configured to store data. Some examples of the memory system 1410 are storage devices, such as RAM or ROM. The memory system 1410 may comprise the RAM cache. In various embodiments, data is stored within the memory system 1410. The data within the memory system 1410 may be cleared or ultimately transferred to the storage system 1415.

The storage system 1415 comprises any storage configured to retrieve and store data. Some examples of the storage system 1415 are flash drives, hard drives, optical drives, and/or magnetic tape. In some embodiments, the digital device 1400 includes a memory system 1410 in the form of RAM and a storage system 1415 in the form of flash data. Both the memory system 1410 and the storage system 1415 comprise computer readable media which may store instructions or programs that are executable by a computer processor including the processor 1405.

The communication network interface (com. network interface) 1420 may be coupled to a data network. The communication network interface 1420 may support communication over an Ethernet connection, a serial connection, a parallel connection, or an ATA connection, for example. The communication network interface 1420 may also support wireless communication (e.g., 802.14a/b/g/n, WiMAX, LTE, 3G, 2G). It will be apparent to those skilled in the art that the communication network interface 1420 may support many wired and wireless standards.

The optional input/output (I/O) interface 1425 is any device that receives input from the user and output data. The display interface 1430 is any device that may be configured to output graphics and data to a display. In one example, the display interface 1430 is a graphics adapter.

It will be appreciated by those skilled in the art that the hardware elements of the digital device 1400 are not limited to those depicted in FIG. 14. A digital device 1400 may comprise more or less hardware elements than those depicted. Further, hardware elements may share functionality and still be within various embodiments described herein. In one example, encoding and/or decoding may be performed by the processor 1405 and/or a co-processor located on a GPU.

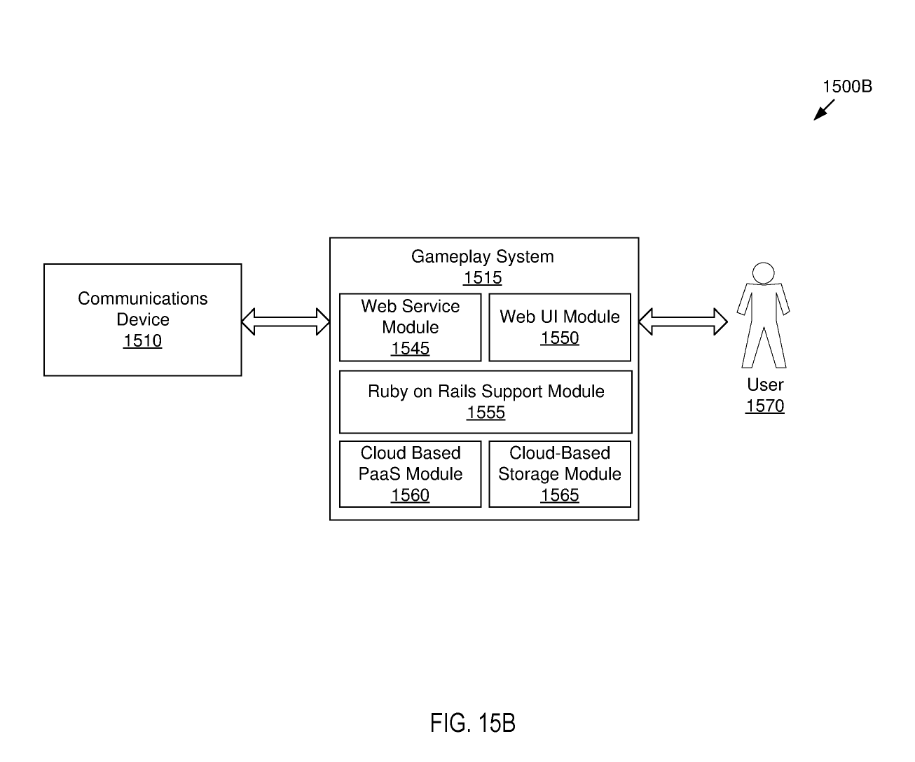

FIG. 15A depicts an example of an augmented reality gaming system 1500, according to some embodiments. The augmented reality gaming system 1500 may include a peripheral system 1505, a communications device 1510, and a gameplay system 1515.

The peripheral system 1505 may include any peripheral system, such as a receiver or an emitter, as discussed herein. In some embodiments, the peripheral system 1505 may correspond to one or more of the emitter 120 and/or the receiver 125, shown in FIG. 1. As such, the peripheral system 1505 may include a transmitter, a receiver, a lens, and other hardware to facilitate sensor-based mobile gaming. The peripheral system 1505 may be paired to the communications device 1510, as discussed herein. The peripheral system 1505 may be coupled to the communications device 1510. In some embodiments, the peripheral system 1505 is coupled to the communications device 1510 using a Bluetooth connection or other wireless connection.

The communications device 1510 may include any digital device, an example of which is the digital device 1400 shown in FIG. 14. In various embodiments, the communications device 1510 may correspond to the player communications device 130, shown in FIG. 1. In some embodiments, the communications device 1510 may include a game application 1520, a peripheral API 1525, a platform API 1530, an API support layer 1535, and a mobile operating system 1540.

In various embodiments, the game application 1520 may allow a user to engage in sensor-based mobile gaming as discussed herein. More specifically, the game application 1520 may include gameplay modules to facilitate sensor-based mobile gaming. In various embodiments, the game application 1520 may include modules corresponding to one or more of the user interface module 410 and the gameplay memory datastore 430, shown in FIG. 4. The game application 1520 may be implemented in any convenient format, including, in various embodiments, an iOS® mobile application or an Android® mobile application.

The peripheral API 1525 may support coupling the communications device 1510 to the peripheral system 1505. In some embodiments, the peripheral API 1525 is implemented as a Bluetooth or other wireless interface to the peripheral system 1505. In various embodiments, the peripheral API 1525 may correspond to some or all of the emitter interface module 415 and the receiver interface module 420, shown in FIG. 4. The platform API 1530 may support coupling the communications device 1510 to the gameplay system 1515. The platform API 1530 may be implemented as a bus, a network interface, or other interface. In various embodiments, the platform API 1530 may correspond to some or all of the gameplay cloud interface module 425, shown in FIG. 4.

The API support layer 1535 may support function calls used by the game application 1520, the peripheral API 1525, and the platform API 1530. In some embodiments, the API support layer 1535 may facilitate receiving and processing user interface inputs, such as gestures, swipes, and clicks. In an implementation, the API support layer 1535 comprises a Cocoa Touch® layer. It is noted the API support layer 1535 may also comprise Android API support layer(s) or other support layer(s) without departing from the scope and substance of the inventive concepts described herein. The mobile operating system 1540 may comprise an operating system of the communications device 1510. In various embodiments, the mobile operating system 1540 may comprise an iOS® operating system or Android® operating system. It is noted the mobile operating system 1540 may comprise other forms of operating systems in some embodiments.

The gameplay system 1515 may support sensor-based gaming by a user of the communications device 1510, as discussed herein. In some embodiments, the gameplay system 1515 may be coupled to the communications device 1510 using a network connection, such as an Internet connection. The network connection may comprise a wireless network connection. The gameplay system 1515 may also be coupled to the communications device 1510 over other convenient connections as known in the art.

FIG. 15B depicts an example of an augmented reality gaming system 1500, according to some embodiments. The augmented reality gaming system 1500 may include a communications device 1510, a gameplay system 1515, and a user 1570.

The communications device 1510 may be coupled to the gameplay system 1515. The communications device 1510 may correspond to the communications device 1510 in FIG. 15A.

The gameplay system 1515 may correspond to the gameplay system 1515 in FIG. 15A. The gameplay system 1515 may include a web service module 1545, a web UI module 1550, a Ruby on Rails support module 1555, a cloud-based Platform as a Service (PaaS) module 1560, and a cloud-based storage module 1565. In some embodiments, the web service module 1545 may be coupled to the communications device 1510. The web service module 1545 may provide sensor-based mobile gaming services, as described herein, as a web service to the communications device 1510. The web UI module 1550 may be coupled to the user 1570. The web UI module 1550 may provide an online portal to access an account associated with the user 1570. The Ruby on Rails support module 1555 may allow the web service module 1545 and the web UI module 1550 to access the cloud-based PaaS module 1560 and the cloud-based storage module 1565. The cloud-based PaaS module 1560 may provide PaaS to other modules. The cloud-based storage module 1565 may provide cloud-based storage to the other modules.

The user 1570 may be any player that utilizes the system. The user 1570 may represent a player seeking to access a web portal associated with sensor-based mobile gaming, as discussed herein. The user 1570 may correspond to the player of the first player communications device 130-1 or the Nth player communications device 130-N, shown in FIG. 1.

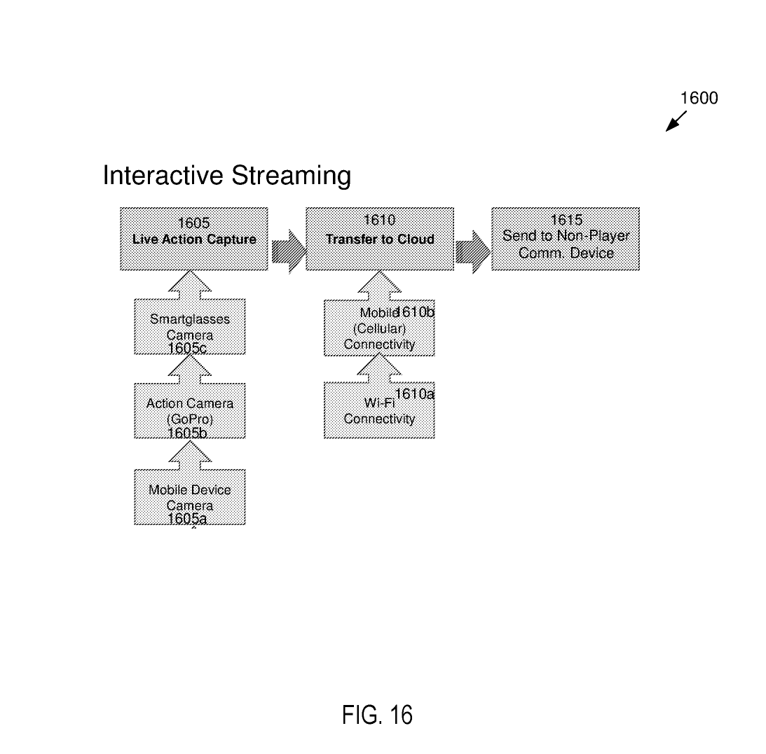

FIG. 16 depicts a flowchart of an example of a method 1600 for facilitating non-player engagement with an augmented reality gaming system, according to some embodiments. At an operation 1605, aspects of an augmented reality electronic game are captured. The operation 1605 may include one or more of: an operation 1605a, capture at a mobile device camera, an operation 1605b, capture at an action camera, and an operation 1605c, capture at a smart-glasses camera. At an operation 1610, the captured data is transferred to the cloud (e.g., to the gameplay system 115). The operation 1610 may include an operation 1610a, transferring the captured data using Wi-Fi connectivity, and an operation 1610b, transferring the captured data using mobile (cellular) connectivity. At an operation 1615, the captured data is sent to a non-player communications device.

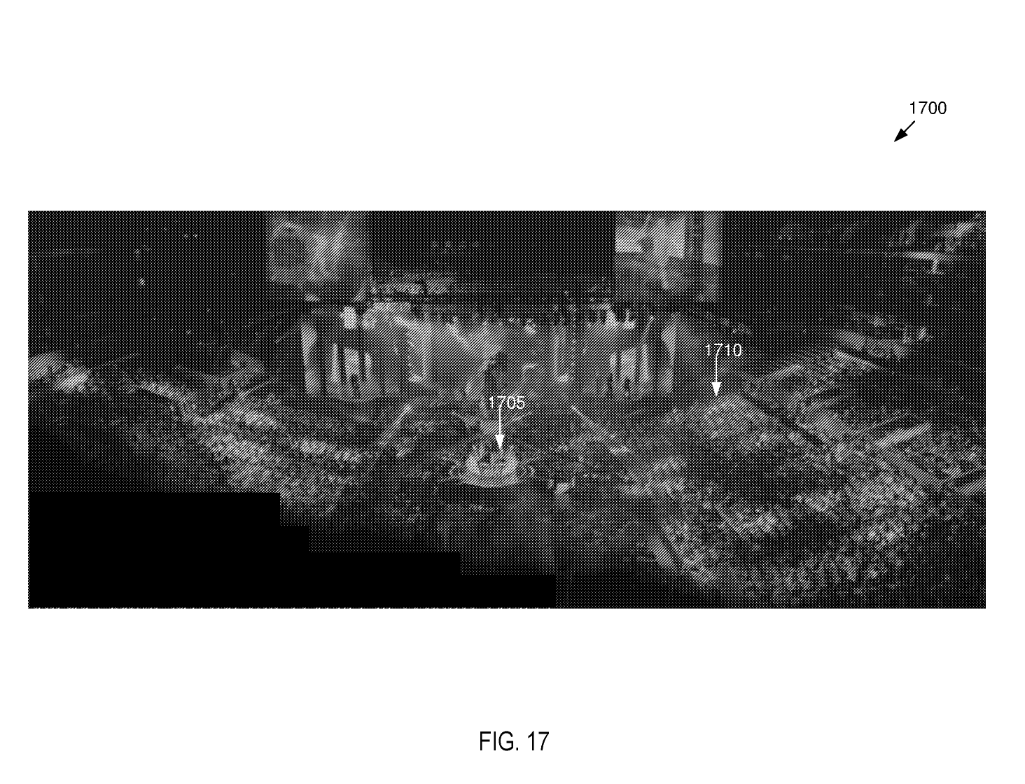

FIG. 17 depicts an example of a facility 1700 used to facilitate non-player engagement with an augmented reality gaming system, according to some embodiments. The facility 1700 may correspond to any physical area in which augmented reality games may be played. As examples, the facility 1700 may correspond to a room or a building in a shopping or other mall, a plaza, a university, etc. As another example, the facility 1700 may correspond to at least a portion of a stadium, such as a university stadium or a municipal sports stadium. In some embodiments, the facility 1700 corresponds to an arena used to support an interactive gaming league.

The facility may include a player area 1705 and a non-player area 1710. The player area 1705 may comprise a portion of the facility 1700 in which players play an augmented reality electronic game. The player area 1705 may correspond to the area within the geo-fences 150 shown in the augmented reality gaming environment 100C. The non-player area 1710 may include an area in which non-players participate in the augmented reality electronic game without engaging in the primary gameplay of the augmented reality electronic game.

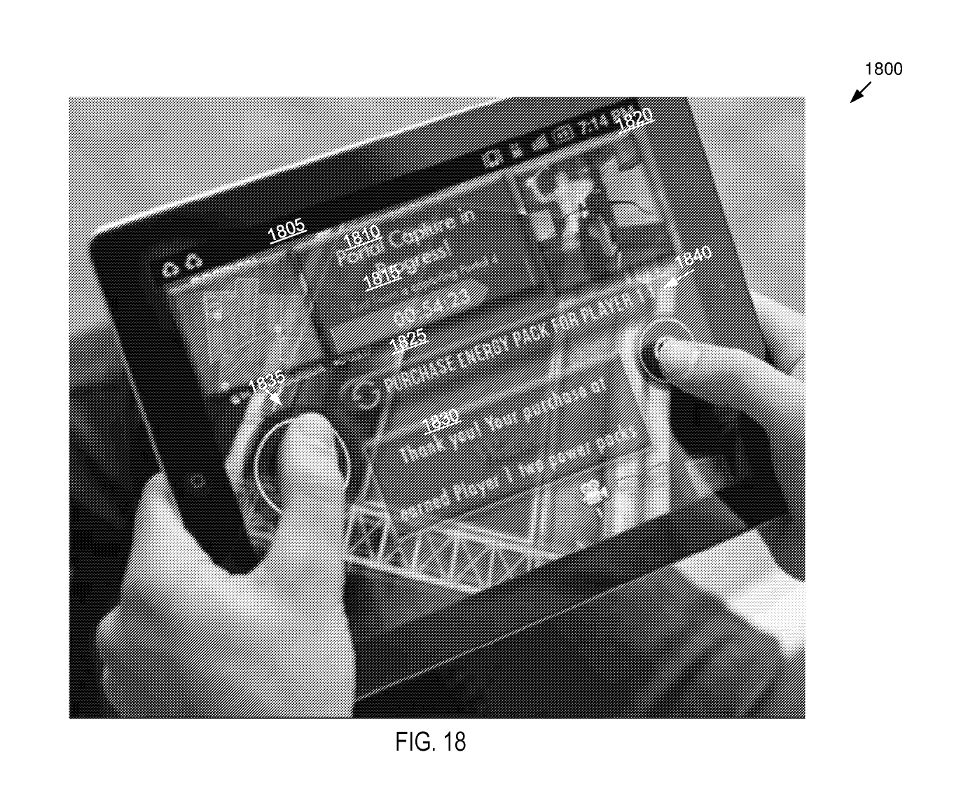

FIG. 18 depicts an example screen 1800 of a non-player communications device used to facilitate non-player engagement with an augmented reality gaming system, according to some embodiments. The screen 1800 may correspond to a screen of the non-player communications devices. The screen 1800 may include a virtual map 1805, a first virtual game status box 1810, an in-game timer 1815, an augmented field of view 1820, a non-player incentive, a second virtual game status box 1830, a first non-player control button 1835, and a second non-player control button 1840. The virtual map 1805 may comprise a map of players and/or virtual objects in a virtual world supported by the augmented reality electronic game. The first virtual game status box 1810 may provide the non-player with a first status related to the augmented reality electronic game (e.g., the status of a portal capture in the augmented reality electronic game). The in-game timer 1815 may provide the non-player with a time that the augmented reality virtual game has been underway.

The augmented field of view 1820 may provide the non-player with a perspective related to the player. In this example, the augmented field of view 1820 shows the player fighting a virtual character holding a sword with a crossbow. The augmented field of view may have been taken from live streaming augmented reality gameplay on a player wearable optical device.

The non-player incentive 1825 may provide the non-player with an option to assist or impede the player (here allowing the non-player to purchase energy for one of the players). In some embodiments, the non-player incentive 1825 provides the non-player with options to vote on mission objectives and/or goals, allow the non-player to purchase additional resources for a player or a player's team (energy/health, ammunition, additional inventory etc.). The second virtual game status box 1830 may provide the non-player with a second status related to the augmented reality electronic game (e.g., the fact that the non-player's purchase at a local retailer earned a player additional energy in the game). The first non-player control button 1835 and the second non-player control button 1840 may allow the non-player to control one or more of the elements referenced herein. The screen 1800 may also be used to opt into retail advertisements pushed by local retailers based on proximity to the augmented reality electronic game. In some embodiments, advertisements may be pushed or based on in-store purchases, depending on game and other mechanics.

The above-described functions and components may be comprised of instructions that are stored on a storage medium such as a computer readable medium. The instructions may be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with some embodiments. Those skilled in the art are familiar with instructions, processor(s), and storage medium.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “some embodiments”, “various embodiments”, “certain embodiments”, “other embodiments”, “one series of embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

As used herein, module may be hardware, software, or a combination of both. As used herein, a module may further include firmware.

The language used herein has been principally selected for readability and instructional purposes, and it may not have been selected to delineate or circumscribe the inventive subject matter. It is therefore intended that the scope be limited not by this detailed description, but rather by any claims that issue on an application based hereon. Accordingly, the disclosure of the embodiments is intended to be illustrative, but not limiting, of the scope, which is set forth in the following claims.

What is claimed is:

1. A computer-implemented method comprising:
receiving first information of a physical player environment associated with gameplay, the first information comprising first video captured by a camera coupled to one or more first player devices of a player in the physical environment, and the first information further comprising physical attributes of the physical environment sensed by a first sensor in the physical environment;
identifying a gameplay action by the player, the gameplay action being taken by the player in relation to a second sensor in the physical environment;
associating one or more virtual objects with the gameplay action based on one or more rules of the gameplay;
creating an augmented field of view of the physical environment for the player based on the virtual objects and the first information of the physical environment;
providing the augmented field of view to one or more second user devices associated with a non-player, the non-player being remote from the physical environment;
receiving from the one or more second user devices a non-player interaction by the non-player; and
modifying a gameplay state of the gameplay based on the non-player interaction.

2. The computer-implemented method of claim 1, wherein the non-player interaction comprises an introduction of a gameplay element into the gameplay.

3. The computer-implemented method of claim 1, wherein the non-player interaction comprises a modification of the virtual object.

4. The computer-implemented method of claim 1, wherein the non-player interaction comprises an instruction to assist the player in an electronic game supported by the gameplay, or an instruction to impede the player in the game.

5. The computer-implemented method of claim 1, wherein the non-player interaction comprises an instruction to control the second sensor in the physical environment.

6. The computer-implemented method of claim 1, wherein the non-player interaction comprises an instruction to control a third sensor in the physical environment.

7. The computer-implemented method of claim 1, wherein non-player interaction comprises a transaction in an in-game economy of an electronic game supported by the gameplay.

8. The computer-implemented method of claim 7, wherein the transaction comprises a purchase in the in-game economy.

9. The computer-implemented method of claim 1, wherein the non-player interaction is based on a virtual currency in an in-game economy of an electronic game supported by the gameplay.

10. The computer-implemented method of claim 9, wherein the virtual currency is based on a digital currency having a value outside the in-game economy.

11. The computer-readable medium of claim 1, wherein the augmented field of view comprises a virtual map of an electronic game supported by the gameplay.

12. The computer-implemented method of claim 1, wherein the first sensor comprises a depth sensor coupled to the camera, and the physical attributes of the physical environment comprise a mesh of the physical environment.

13. The computer-implemented method of claim 1, wherein the first sensor comprises a positional tracking sensor coupled to the one or more first player devices, and the physical attributes of the physical environment comprise positional information of physical objects in the physical environment, the positional information captured by the positional tracking sensor.

14. The computer-implemented method of claim 13, wherein the positional tracking sensor comprises one or more of a Global Positioning System (GPS) sensor, a Simultaneous Localization and Mapping (SLAM) sensor, and a Bluetooth Low Energy (BLE) sensor.

15. The computer-implemented method of claim 13, wherein the positional information comprises one or more positional markers gathered by the positional tracking sensor.

16. The computer-implemented method of claim 1, wherein creating the augmented field of view of the physical environment comprises combining the virtual objects and the first information of the physical environment at a server remote from the one or more first player devices and the one or more second user devices.

17. The computer-implemented method of claim 1, wherein creating the augmented field of view of the physical environment comprises combining the virtual objects and the first information of the physical environment at the one or more second user devices.

18. The computer-implemented method of claim 1, wherein providing the augmented field of view comprises sending a streaming video of the augmented field of view to the one or more second user devices.

19. The computer-implemented method of claim 1, further comprising sending the augmented field of view to the one or more first player devices.

20. The computer-implemented method of claim 19, wherein the one or more first player devices comprises at least one of: a heads-up-display (HUD), a mobile phone, and a tablet computing device.

21. The computer-implemented method of claim 1, wherein the camera comprises one or more of a mobile phone camera, a heads-up-display (HUD), and an action camera.

22. The computer-implemented method of claim 1, wherein the first video is relayed to the one or more first player devices by the camera after the camera has captured the first video.

23. A system comprising:
one or more processors; and
memory coupled to the one or more processors, the memory containing instructions executable by the processor to execute:
a player environment interface module configured to receive first information of a physical player environment associated with gameplay, the first information comprising first video captured by a camera coupled to one or more first player devices of a player in the physical environment, and the first information further comprising physical attributes of the physical environment sensed by a first sensor in the physical environment;
a gameplay management module configured to identify a gameplay action by the player, the gameplay action being taken by the player in relation to a second sensor in the physical environment, to associate one or more virtual objects with the gameplay action based on one or more rules of the gameplay, and to create an augmented field of view of the physical environment for the player based on the virtual objects and the first information of the physical environment;
a non-player device interface module configured to provide the augmented field of view to one or more second user devices associated with a non-player, the non-player being remote from the physical environment;
a non-player interaction processing module configured to receive from the one or more second user devices a non-player interaction by the non-player; and
a non-player instruction management module configured to instruct the gameplay management module to modify a gameplay state of the gameplay based on the non-player interaction, the game.

24. A non-transitory computer-readable medium comprising one or more processors and memory coupled to the one or more processors, the memory comprising computer-program instructions configured to instruct the one or more processors to perform a computer-implemented method, the computer-implemented method comprising:
receiving first information of a physical player environment associated with gameplay, the first information comprising first video captured by a camera coupled to one or more first player devices of a player in the physical environment, and the first information further comprising physical attributes of the physical environment sensed by a first sensor in the physical environment;
identifying a gameplay action by the player, the gameplay action being taken by the player in relation to a second sensor in the physical environment;
associating one or more virtual objects with the gameplay action based on one or more rules of the gameplay;
creating an augmented field of view of the physical environment for the player based on the virtual objects and the first information of the physical environment;
providing the augmented field of view to one or more second user devices associated with a non-player, the non-player being remote from the physical environment;
receiving from the one or more second user devices a non-player interaction by the non-player; and
modifying a gameplay state of the gameplay based on the non-player interaction.
